(19) United States
(12) Patent Application Publication
(10) Pub. No.: US 2026/0050851 A1
(43) Pub. Date: Feb. 19, 2026

(54) COMPUTE MANAGEMENT SYSTEM FOR EVENT-DRIVEN TASK PRIORITIZATION AND ASSIGNMENT

(71) Applicant: Lineage Logistics, LLC, Irvine, CA (US)

(72) Inventors: Daniël Walet, Oakland, CA (US); Daniel Thomas Wintz, San Francisco, CA (US); Noah James Garnier, Decatur, GA (US); Daniel Bolis, Brooklyn, NY (US); Kaitlyn Garifi, Irvine, CA (US); Drew Smith, Austin, TX (US)

(21) Appl. No.: 19/369,694

(22) Filed: Oct. 27, 2025

Related U.S. Application Data
(63) Continuation-in-part of application No. 17/831,404, filed on Jun. 2, 2022.
(60) Provisional application No. 63/196,156, filed on Jun. 2, 2021.

(51) Int. Cl. G06Q 10/0631

(52) U.S. Cl. CPC G06Q 10/06312; G06Q 10/06311; G06Q 10/06317

(57) ABSTRACT

Disclosed herein are techniques for computationally efficient scoring and prioritization of resources. A method can include receiving a data request for a resource assignment in an operational environment, retrieving a queue of candidate resources associated with the operational environment, generating a dynamic score for at least one candidate resource in the queue of candidate resources based at least in part on the received data request, updating a prioritized resource list based on the dynamic score for the at least one candidate resource, the prioritized resource list including a group of resources having respective dynamic scores, assigning a resource from the prioritized resource list that satisfies one or more assignment criteria based on the received data request, and returning instructions that cause the assigned resource to be executed.

### CROSS-REFERENCE TO RELATED APPLICATIONS

This application is a continuation-in-part (CIP) of U.S. patent application Ser. No. 17/831,404, entitled “Swapping Task Assignments to Determine Task Selection,” filed Jun. 2, 2022, which claims priority to and the benefit of U.S. Provisional Patent Application No. 63/196,156, filed Jun. 2, 2021, the entire contents of each of which are incorporated herein by reference.

### TECHNICAL FIELD

This document describes devices, systems, and methods related to efficient compute management operations for event-driven task prioritization and assignment.

### BACKGROUND

A warehouse or other storage facility can be used to store items. Items can be stored for different periods of time and under different storage conditions, which can be based on a vendor, customer, or other relevant user. Items can be stored until they are requested by a relevant user, such as a customer. While the items are being stored, they can also be moved around the warehouse to different storage locations.

Tasks can be assigned to different workers in the warehouse. Sometimes, determining which tasks to assign to which workers can take significant amounts of time. Since a state of the warehouse can also change by the minute, such assignments may not take into consideration the changes to the state of the warehouse. Thus, the workers may not complete their assigned tasks efficiently.

Moving the items around the warehouse can also require time and energy. Sometimes, a warehouse worker can be assigned tasks that are completed and started in different locations in the warehouse. The warehouse worker must therefore travel from a location of the completed task to a location of the new task that needs to be started. While traveling this distance, the warehouse worker can encounter holdups, such as traffic. Moreover, the warehouse worker can spend significant amounts of time traveling this distance instead of completing tasks, thereby reducing efficiency of the warehouse worker as well as overall warehouse efficiency.

Additionally, some warehouse workers may be designated to only complete inbound tasks or outbound tasks but not both. Such warehouse workers can therefore be assigned tasks that require them to complete inbound tasks, then return to where they started to complete new inbound tasks. Such task assignments can result in decreased efficiency since the warehouse workers can be spending significant amounts of time traveling between tasks rather than completing tasks.

### SUMMARY

The document relates to determining task prioritizations, selections, and assignments using event-driven scoring techniques that reduce CPU cycles and network chatter. More specifically, the disclosed technology provides for prioritization of tasks in an operational environment. Such prioritization can result in computational and resource efficiencies, improved network bandwidth usage, and accuracy in real-time processing. The disclosed technology can include incremental priority queues where each task or resource has a dynamic priority score. Sometimes, the queue(s) can be maintained as a heap so that pulling a next best task or resource and updating the scores can be fast, efficient, and accurate. Advantageously, using heaps for maintaining the queue(s) allows for keeping track of next best tasks without rescoring or resorting every time there is a need for task selection/assignment and/or recomputing of one or more priority scores in the queue(s). Thus, with the disclosed techniques, only tasks or resources whose scores change would be updated in the heap. Moreover, instead of recomputing every task or resource score at predetermined time intervals (which can burn CPU and network usage), the disclosed technology may update the scores only upon identification of specific events. Advantageously, the disclosed technology lowers CPU cycles as it only computes when and where needed, touching only a subset of tasks/resources each time. These operations also lower network chatter; instead of sending entire refreshed queues, sometimes the disclosed technology may only transmit delta. The use of heaps also can make next-best queries constant with real-time responsiveness. Local caching may also keep the operations running, especially where the disclosed technology is deployed on edge devices and hardware having intermittent network connectivity.

Scoring mechanisms described herein may be deployed using lightweight edge computing hardware and devices to provide fast processing and real-time results. Network bandwidth usage may be reduced with delta-based messaging. Next tasks and/or priority change packets may be transmitted amongst computing devices and resources, rather than complete tasks lists. This can cut down payloads by orders of magnitude, especially in light of frequent changes to the operational environment. The disclosed technology further provides tolerance to intermittent connectivity as local queue caching allows for continued operation without constant server roundtrips.

The disclosed technology includes numerous additional features that can be implemented in various use cases, including those use cases described further below. For example, the disclosed technology can perform congestion minimization operations with real-time penalties as a way to reduce computational and resource usage, improve network bandwidth usage, and improve processing efficiency. The disclosed technology can perform real-time dynamic adjustments of task assignments and/or resource allocation based on one or more operational conditions associated with resources. Similarly, the disclosed technology can provide granular task assignment with real-time resource-polling operation to improve overall processing efficiencies and use of compute resources.

One or more embodiments described herein can include a method for computationally efficient scoring and prioritization of resources, the method including: receiving a data request for a resource assignment in an operational environment, retrieving a queue of candidate resources associated with the operational environment, generating a dynamic score for at least one candidate resource in the queue of candidate resources based at least in part on the received data request, updating a prioritized resource list based on the dynamic score for the at least one candidate resource, the prioritized resource list including a group of resources having respective dynamic scores, assigning a resource from the prioritized resource list that satisfies one or more assignment criteria based on the received data request, and returning instructions that cause the assigned resource to be executed.

The embodiments can optionally include one or more of the following features. For example, the data request can include a current location and last-resource information. The resource can include a task to be performed in the operational environment, the operational environment including a facility. Generating the dynamic score for the at least one candidate resource in the queue of candidate resources can include identifying a subset of candidate resources in the queue of candidate resources that can be associated with the received data request, the subset of candidate resources including the at least one candidate resource. In response to receiving a second data request for a second resource assignment, the method further can include: identifying a subset of resources in the prioritized resource list that can be associated with the second data request, recomputing respective dynamic scores for the subset of resources, and updating the prioritized resource list based on the recomputed dynamic scores for the subset of resources. The second data request can include completion of scanning a pallet in the operational environment. The second data request can include an update in dock door assignment in the operational environment or truck ETA to the operational environment.

As another example, the generating, updating, and assigning can be configured to lower CPU cycles by at least a threshold amount. Updating the prioritized resource list can include increasing or decreasing a position of the at least one candidate resource in the prioritized resource list based on the dynamic score. The prioritized resource list can be a heap and the dynamic scores of the group of resources can be heap keys for the group of resources. The group of resources can be ranked from highest dynamic score to lowest dynamic score in the prioritized resource list. Returning the instructions that cause the assigned resource to be executed can include transmitting instructions to a facility vehicle in the operational environment that, when executed, can cause the facility vehicle to perform operations based on the assigned resource. Assigning the resource from the prioritized resource list that satisfies the one or more assignment criteria based on the received data request can include selecting and assigning a highest-ranked resource in the prioritized resource list.

In some implementations, the group of resources can include a group of tasks to be performed in the operational environment, the data request can be received from a worker in the operational environment, and the data request can include a location of the worker in the operational environment. Assigning the resource from the prioritized resource list that satisfies the one or more assignment criteria based on the received data request can include selecting and assigning a highest-ranked resource in the prioritized resource list that can be within a threshold distance of the location of the worker in the operational environment. The method further can include: generating congestion scores for each zone in a group of zones in the operational environment, identifying and tagging zones in the group of zones as high congestion zones based on a determination that the tagged zones have corresponding congestion scores that exceed a threshold value, for each candidate resource in the queue of candidate resources, applying a penalty score to a respective dynamic score for the candidate resource to generate an updated dynamic score for the candidate resource based on the candidate resource being associated with at least one of the high congestion zones, and updating the prioritized resource list based on the updated dynamic score for the candidate resource. Sometimes, updating the prioritized resource list based on the updated dynamic score for the candidate resource can include deprioritizing the candidate resource in the prioritized resource list.

One or more embodiments described herein can include a system for computationally efficient scoring and prioritization of resources, the system including: one or more processors and memory storing instructions that, when executed, cause the one or more processors to perform operations that can include: receiving a data request for a resource assignment in an operational environment, retrieving a queue of candidate resources associated with the operational environment, generating a dynamic score for at least one candidate resource in the queue of candidate resources based at least in part on the received data request, updating a prioritized resource list based on the dynamic score for the at least one candidate resource, where the prioritized resource list can include a group of resources having respective dynamic scores, assigning a resource from the prioritized resource list that satisfies one or more assignment criteria based on the received data request, and returning instructions that cause the assigned resource to be executed.

The system can optionally include one or more of the abovementioned features and/or one or more of the following features. For example, in response to receiving a second data request for a second resource assignment, the operations further can include: identifying a subset of resources in the prioritized resource list that can be associated with the second data request, recomputing respective dynamic scores for the subset of resources, and updating the prioritized resource list based on the recomputed dynamic scores for the subset of resources. The group of resources can include a group of tasks to be performed in the operational environment, the data request can be received from a worker in the operational environment, and the data request can include a location of the worker in the operational environment. Assigning the resource from the prioritized resource list that satisfies the one or more assignment criteria based on the received data request can include selecting and assigning a highest-ranked resource in the prioritized resource list that can be within a threshold distance of the location of the worker in the operational environment. The operations further can include: generating congestion scores for each zone in a group of zones in the operational environment, identifying and tagging zones in the group of zones as high congestion zones based on a determination that the tagged zones have corresponding congestion scores that exceed a threshold value, for each candidate resource in the queue of candidate resources, applying a penalty score to a respective dynamic score for the candidate resource to generate an updated dynamic score for the candidate resource based on the candidate resource being associated with at least one of the high congestion zones, and updating the prioritized resource list based on the updated dynamic score for the candidate resource.

The disclosed technology can provide one or more of the following technical advantages. For example, the disclosed technology reduces compute and bandwidth usage compared to existing systems. As a result, the disclosed technology provides for higher throughput and accuracy with priority queues, congestion penalties, and location-aware micro-tasking to increase task continuity, reduce rehandling of tasks and/or resources in an operational environment, and/or lower mis-assignments of tasks and/or resources in the operational environment. The disclosed technology can therefore result in improved real-time behavior, where adaptive and multi-objective scoring techniques respond to various factors in the operational environment in real-time and without requiring global recalculations. Deterministic algorithms and telemetry feedback can be integrated with the disclosed technology to improve reliability and repeatability, thereby outperforming any human heuristics, especially under scale, volatility, and/or constraint stacking.

As another example, the disclosed technology provides for processing efficiency, accuracy, and real-time determinations. Continuous assignment of resources can prevent idle time, such as idle dock time in warehouse environments. The continuous assignments can also avoid out-of-order loading of resources, such as trucks, to reduce re-handling and double travel of these resources. The disclosed technology may also incorporate sequence-aware constraints into prioritization operations to reduce potentially costly post-hoc corrections. As new tasks may appear in real-time, prioritization operations can be dynamically updated also in real-time without waiting for batch cycles, thereby improving overall processing efficiencies.

The disclosed technology provides technical solutions to technical gaps in existing task assignment and prioritization systems. For example, the disclosed technology overcomes static picklists and distance-only heuristics in warehouse environments, which may ignore trailer/truck constraints and result in rework and/or bottlenecks at doors or other resources in the environment. The disclosed technology also addresses the technical gaps in the existing systems by replacing batch cycling prioritization with reactive prioritization assignments that scale with event frequency and real-time changes in the operational environment. None of these techniques can be reasonably performed in the human mind in real-time, such as processing complex digital data to continuously recompute ranks across large amounts of resources and constraints with shifting time thresholds.

Additionally, the disclosed technology provides congestion minimization operations that include real-time congestion awareness in resource task assignment through continuous, real-time tracking of the resources in an operational environment. The disclosed technology can apply dynamic penalties to tasks that would route resources into congested operations and/or zones, effectively spreading activity across the operational environment to reduce bottlenecks and improve completion of the tasks. By leveraging live telemetry and lightweight spatial models, the disclosed technology can make sub-second adjustments without requiring full path recalculations. This approach addresses limitations of traditional systems that rely solely on time-based metrics or static rules, which often lead to congestion, conflicts, and operational slowdowns.

Dynamic adjustment of task assignments can also provide for dynamically rebalancing priorities between minimizing certain time-based metrics while meeting time-sensitive objectives. When operations are ahead of schedule, for example, the disclosed technology can favor shorter time-based metrics to reduce resource fatigue/overuse and optimize overall efficiency. Conversely, if an operation falls behind schedule, the disclosed technology can increase the weighting on the time-based metrics to accelerate completion of critical tasks. This adaptive scoring mechanism ensures that decisions remain aligned with real-time optimization goals without requiring costly global re-optimizations, something that existing static rule-based systems cannot achieve.

Moreover, the disclosed technology leverages granular task assignment and real-time task polling of resources to provide granular, location-aware micro-tasks based on particular real-time conditions of the resources and operational priorities. This real-time polling can reduce idle time of available resources and minimize unnecessary time-based metrics. Unlike static rule-based systems, which can become outdated quickly, the disclosed approach can ensure that resource and task assignments remain accurate and efficient in dynamic environments.

The devices, system, and techniques described herein may provide one or more additional advantages in various use cases. For example, the disclosed technology can be used to reduce an amount of travel time or distance between tasks for warehouse workers. Typically, a warehouse worker may be assigned only inbound tasks or only outbound tasks but not both. For example, the warehouse worker may be assigned a queue of inbound tasks and another warehouse worker may be assigned a queue of outbound tasks. Using the disclosed technology, the warehouse worker can be assigned both inbound and outbound tasks in order to reduce an amount of time that the warehouse worker may spend traveling between tasks. As a result, the warehouse worker's efficiency can improve as well as overall warehouse efficiency. For example, the warehouse worker can complete an inbound task. The disclosed technology can select an outbound task to be completed next by the warehouse worker if completing the outbound task is likely to improve the worker's overall efficiency. The outbound task can be selected from another warehouse worker's queue of outbound tasks. In other words, the disclosed technology can provide for swapping a next inbound task on the warehouse worker's queue with an outbound task on another warehouse worker's queue. The swapped outbound task can start at a location that is close to a location where the warehouse worker completed the inbound task. Thus, the warehouse worker can travel a shorter distance and spend less time moving between the current location and the location of the outbound task. By reducing the travel distance and/or time for the warehouse worker, worker efficiency as well as warehouse efficiency can be improved.

As another example, the disclosed technology can provide for reducing or otherwise preventing congestion in the warehouse. By assigning a warehouse worker a next task that is closest to a current location of a completed task, the warehouse worker may not be required to travel great distances to start the next task. When traveling greater distances to a next task, on the other hand, the warehouse worker may be more likely to encounter traffic or other holdups in the warehouse, which can further reduce efficiency of the worker and the overall warehouse. The disclosed technology therefore provides for the warehouse worker to spend less time and distance traveling between tasks, which also can assist the warehouse worker in avoiding traffic in the warehouse. The warehouse worker can complete their task(s) faster and more efficiently, which can increase overall warehouse efficiency.

The disclosed technology can also provide for maintaining an on-time truck loading and unloading service level. The warehouse can be expected to complete tasks efficiently and timely such that truck loading and unloading tasks can remain on-time. Since the disclosed technology provides for reducing an amount of time spent moving between tasks, the warehouse workers can more efficiently and quickly complete their tasks. The more efficiently and quickly that tasks are completed, the greater likelihood that the warehouse can provide for on-time truck loading and unloading services. When trucks are loaded and unloaded on time, the warehouse as a whole, as well as customers and other relevant stakeholders, may continue to operate efficiently and/or without delays. More efficient performance of tasks can reduce physical movement of moving machines (e.g., lift trucks), therefore reducing energy usage and wear and tear of the moving machines.

As another example, the disclosed technology can be computationally efficient. Every time that a task swap is assessed using the disclosed technology, any dynamic changes that may have occurred to a state of the warehouse can be taken into consideration. Global efficiency of the swap can then be assessed relative to any current changes to the state of the warehouse. Thus, task selection based on the swap can be more accurate and relative to the current state of the warehouse rather than based on prior states of the warehouse. Overall warehouse efficiency can be improved.

The details of one or more implementations are set forth in the accompanying drawings and the description below. Other features and advantages will be apparent from the description and drawings, and from the claims.

### BRIEF DESCRIPTION OF THE DRAWINGS

FIG. 1A is a conceptual diagram of a system for computationally-efficient event-based task prioritization and assignment.

FIG. 1B is a conceptual diagram of a state of a warehouse environment at initial task assignment.

FIG. 2 is a conceptual diagram of a state of the warehouse environment after a first swap of task assignments.

FIG. 3 is a conceptual diagram of a state of the warehouse environment after a second swap of task assignments.

FIGS. 4A-E is a flowchart of a process for determining an optimal task selection for a warehouse operator.

FIG. 5 is a flowchart of a process for assigning a warehouse operator a next task to complete.

FIG. 6 is a schematic diagram that shows an example of a computing device and a mobile computing device that can be used to perform the techniques described herein.

FIG. 7 is a flowchart of a process for prioritization of tasks in an environment.

FIG. 8 is a flowchart of a process for minimizing congestion in the environment based on penalty-scoring of task assignments.

FIG. 9 is a flowchart of a process for dynamically adjusting task assignment priorities based on operational conditions.

FIGS. 10A and 10B are a flowchart of a process for granular and real-time task assignment.

Like reference symbols in the various drawings indicate like elements.

### DETAILED DESCRIPTION OF ILLUSTRATIVE EMBODIMENTS

This document relates to determining optimal and efficient operations in an operational environment using event-driven, incremental scoring techniques that reduce CPU cycles and network chatter.

As an illustrative use case example, the disclosed technology can provide for selecting and allocating optimal tasks to warehouse workers in a manner that can provide a greatest global efficiency across tasks and warehouse workers. Selection and allocation of optimal tasks can be a heuristic that balances computational load and efficiency with optimizing results. Thus, the disclosed technology can be used to select what next task can be provided to a warehouse worker. The disclosed technology can provide for choosing a next task from a set of tasks that are currently ready for execution. If a task cannot yet be executed because a pre-existing task is not yet completed, then that task may not be included in the set of tasks that are currently ready for execution. The disclosed technology therefore balances selection of a best possible task to complete next with minimizing waste of motion of warehouse workers, preventing congestion in the warehouse, and maintaining an on-time truck loading and unloading service level.

Each of multiple warehouse workers can be assigned a queue of tasks to complete. When the warehouse worker is ready to complete a new task, the disclosed technology can be used to determine whether a next task in the warehouse worker's queue is the best task to complete next. For example, the disclosed technology can determine whether the warehouse worker's time and energy will be efficiently utilized by moving from the worker's current task to the next task in the worker's queue. In some implementations, the worker can complete an inbound storage task and the disclosed technology can select an outbound task that begins closest to where the inbound storage task ends. As a result, the worker may spend little time moving between the inbound task and the outbound task, thereby improving the worker's efficiency.

To determine utilization efficiency, the disclosed technology can provide for swapping a task in the worker's queue with a task in another warehouse worker's queue of tasks. The disclosed technology can then determine a global efficiency metric based on whether efficiency improves for either of the warehouse workers if they are to complete their respective queues with the swapped tasks. Efficiency can be improved if either of the workers travels less distance either before or after a swapped task. Efficiency can also be improved if either of the workers travels in less time when performing their entire queue of tasks, with the tasks swapped. Efficiency can therefore be improved if, per worker, travel time/distance is reduced and/or aggregate travel time/distance for all workers is reduced. If efficiency improves, then the disclosed technology can send instructions to the warehouse workers in accordance with the revised queues of tasks. If efficiency does not improve, then the disclosed technology can revert the task assignments to the task assignments before the swap. The disclosed technology can continue to swap tasks between different worker queues and assess the global efficiency metric in order to determine optimal task selection.

The global efficiency metric can be based on how long a warehouse worker has to travel between tasks (e.g., without moving a storage item, such that the travel time is largely unproductive movement). The more time the warehouse worker has to spend traveling between tasks, the less efficient the warehouse worker in in completing the worker's queue of tasks. In some implementations, pick up or put away locations of a pallet for a task in the worker's queue can be swapped. For example, a put away location for the pallet can be swapped with a location that is closer to a current location of the warehouse worker. As a result, the global efficiency metric can improve since the warehouse worker may not be traveling a long time to complete the next task. In some implementations, the disclosed technology can swap a pallet in the worker's next task with a different pallet of a same type, wherein the different pallet can be closer to a current location of the warehouse worker or otherwise easier and faster to grab by the worker. As a result, the global efficiency metric can improve.

The techniques described herein can be used to select optimal tasks for a docking area, full pallet movements within the warehouse, and case picking. For example, the docking area can require tasks such as loading, unloading, and receiving pallets from trucks. Full pallet movements can include tasks that move a full pallet from one location in the warehouse to another location, such as putting away the full pallet, staging, and replenishment. The full pallet can be completely built and identified. The full pallet can be a built case pick pallet. Moreover, case picking can include tasks such as building a mixed pallet by picking cases. The disclosed technology can be used in each of these three categories of task selection in order to improve overall warehouse efficiency.

The disclosed technology can provide for building pick pallets on an aisle basis. Less-than-full pallets generated per aisle can then be combined into mixed pallets. The disclosed technology can also provide for minimizing damage or crushing of items that are layered in the pick pallets. Moreover, the disclosed technology can minimize labor required to pick items to build the pallets while also minimizing pick-path lengths.

The disclosed technology can be applied to both manual and automated warehouses. In a manual warehouse, a call to determine a pick pallet build operation can be made at a point that a pick order request is received. This call can populate placeholder tasks in a task queue to allow for labor scheduling and other planning purposes needed to fulfill the pick order request in a timely fashion. Additional calls can be made before a first pick task is performed in order to determine the pick pallet build operation based on latest conditions in the warehouse. The manual pick operation call can return, for each pick pallet to build, (1) a set of SKUs on the pick pallet, (2) for each SKU on the pick pallet, a set of locations that can satisfy the pick (which can also satisfy a first-in-first-out order), (3) an order that items should be picked relative to others, and (4) a number of items that need to be picked of each SKU.

In an automated warehouse (e.g., where there is automatic layer picking and/or a manual pick-to-belt operation), a call to determine a pick pallet build operation can also be made at a point that a pick order request is received. However, in a manual pick operation, each build-order for a single pallet can be distinct from other build lines. In the automated pick operation, one or more layers that have a same or similar build order may be interchangeable while building the pallet. The one or more layers can also be interchangeable based on crushability of products on each of the one or more layers. For at least these reasons, output from the automated pick operation call can be different than output from the manual pick operation call. Such flexibility in the automated pick operation call can provide for opportunity to determine a best order in which to execute each layer picker task.

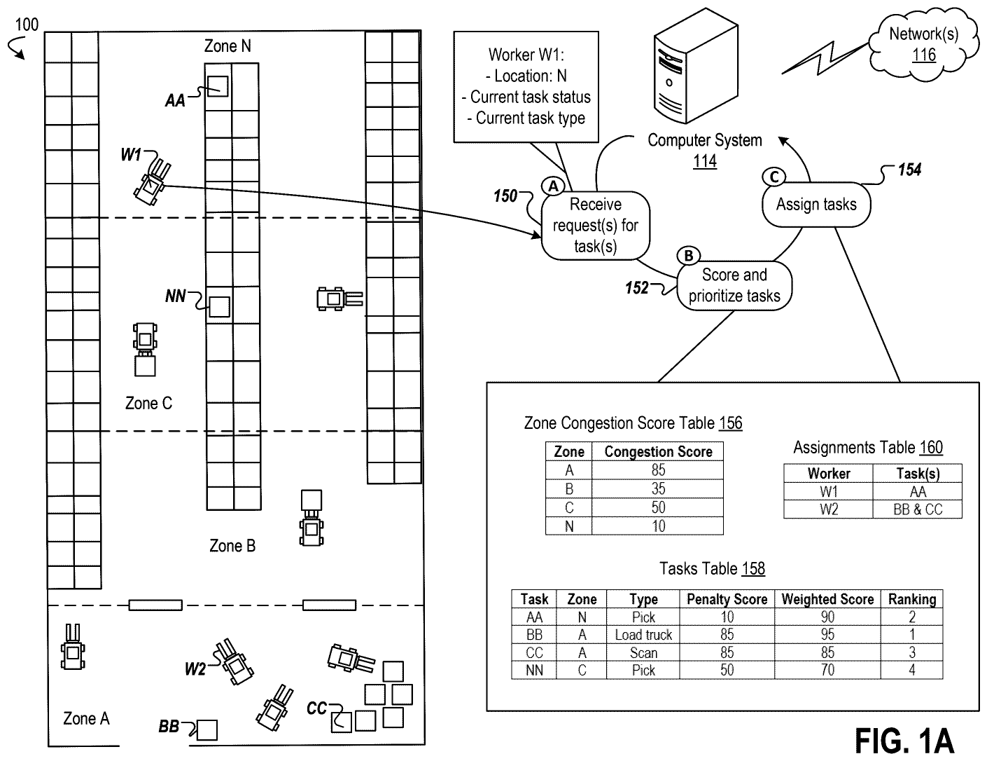

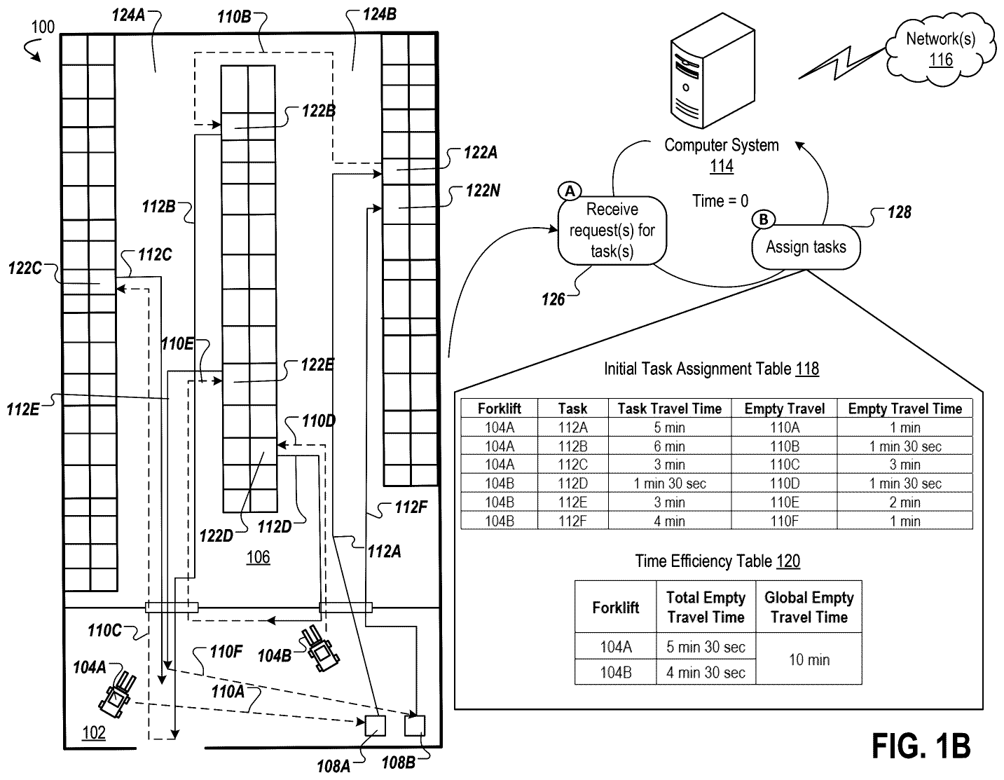

Now referring to the figures, FIG. 1A is a conceptual diagram of a warehouse environment 100 for computationally-efficient event-based task prioritization and assignment. The example warehouse environment 100 (e.g., facility) shows current locations of various vehicles (e.g., workers), including but not limited to workers W1 and W2. The workers W1 and W2 can be assigned tasks to complete in the environment 100, as described below.

The warehouse environment 100 can also include various objects that can be moved throughout the environment 100 and thus associated with tasks, such as but not limited to tasks AA, BB, CC, and NN. The objects, as described further in reference to at least FIG. 1B, can include full pallets, partially-built pallets, cases or boxes of items, and/or other items.

The warehouse environment 100 can also include multiple zones, such as but not limited to zones A, B, C, and N. Each of the zones A-N can be designated for different types of items, temperature storage conditions, length of storage, and/or other storage and/or customer-related requirements/conditions. In the example of the environment 100 in FIG. 1A, zone A, for example, can be a dock area of the environment 100 and zones B-N can be storage areas with different storage requirements and/or conditions.

In order to determine task selection and assignment for workers in the environment such as the workers W1 and W2, the workers W1 and W2 can communicate with a computer system 114 via network(s) 116 (e.g., wired and/or wireless communication). More specifically, handheld devices or other computing devices associated with the workers W1 and W2 can communicate with the computer system 114. The computer system 114 can be configured to determine task selection and assignment as described herein (e.g., refer to FIG. 1B).

In this illustrative example, a device associated with the worker W1 can transmit a request for a task to the computer system 114. The computer system 114 can be configured to receive the request from the worker W1's device (block A, 150). As described herein, the request can include information such as a current location of the worker W1 (e.g., where the worker completed their last task), a current task status (e.g., whether the worker completed the task, is near completion, has not started the task), and/or a current task type (e.g., picking, putting away, building pallets, loading trucks, scanning pallets). Although FIG. 1A shows only information about a request that is received from the worker W1 device, this is a non-limiting example. The computer system 114 can receive many requests from different vehicles and workers in the environment 100 in real-time, at a same time, and/or at different times.

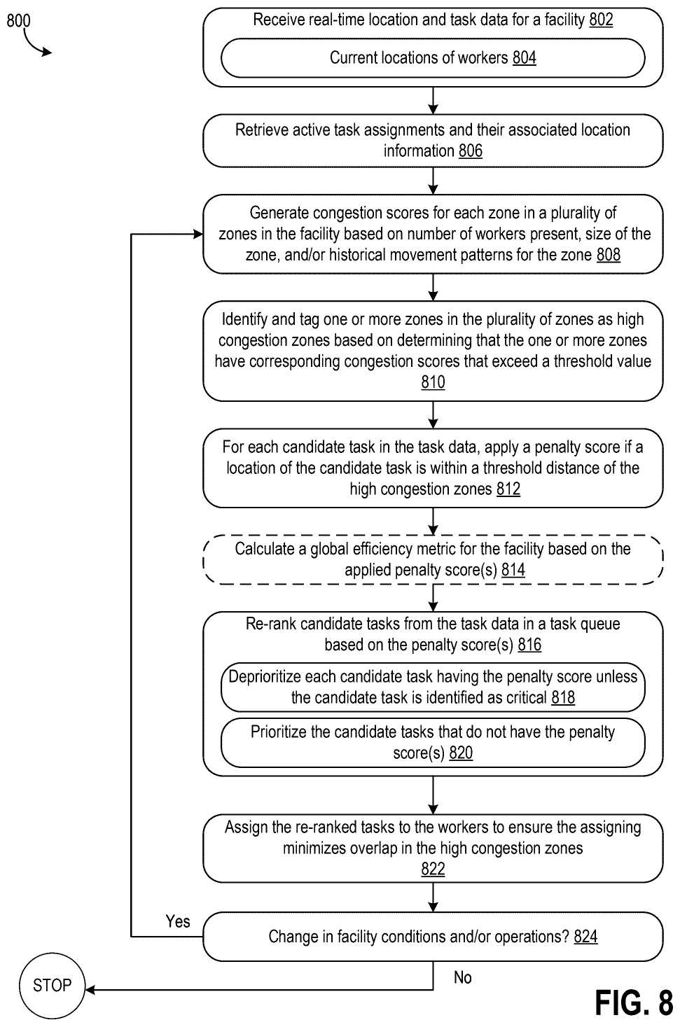

The computer system 114 can score and prioritize tasks that need to be performed in the environment 100 using computationally-efficient techniques described herein in block B (152). For example, the computer system 114 can generate a zone congestion table 156 (e.g., data matrix, other data structure). The table 156 can include information about each of the zones A-N in the environment 100. For example, the computer system 114 can predict or otherwise determine congestion in each of the zones A-N for a current time and/or a future/upcoming time. Based on the predicted congestion in each of the zones A-N, the computer system 114 can generate respective congestion scores. Refer to at least FIG. 8 for further discussion about congestion scoring. In this example, the zone A, which is the dock area of the environment 100, can have the most congestion of the zones A-N. This can be the case where one or more trucks have arrived and unloading and/or loading tasks are prioritized or otherwise being performed. The zone A can also be the most congested zone because there are more workers/vehicles and/or more pallets/items being moved around in that zone relative to other zones. As another example, zone N can be a least congested zone because minimal tasks are currently being performed in that zone and/or the zone N is associated with more long-term storage requirements (which means that pallets or items are not frequently pulled or put away in the zone N). Here, only the worker W1 may be in the zone N, further showing that the zone N is least congested of the zones A-N.

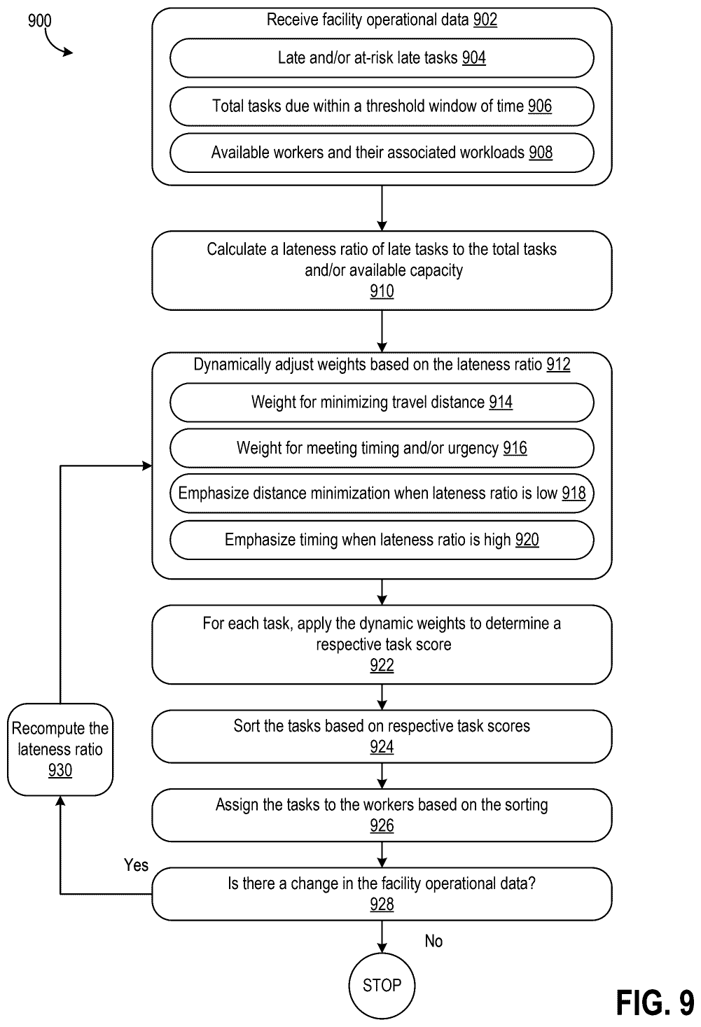

As another example of scoring and prioritizing tasks (block B, 152), the computer system 114 can generate a tasks table 158. The tasks table 150 can indicate each candidate task to be performed in the environment 100 and associated task information. The associated task information can include but is not limited to a zone associated with the task (e.g., a start location of the task, a finish location of the task), a type of task, a penalty score, a weighted score, and/or a ranking. Sometimes, the type of task information can be used by the computer system 114 to determine whether to assign similar tasks to a worker, such as the worker W1. For example, if the worker W1 just performed a putting away or picking task in the zone N, then the computer system 114 may determine that the worker W1 should perform a similar task in that zone. The penalty score for each of the tasks AA-NN can be determined by the computer system 114 based on the congestion scores for the zones A-N in the zone congestion score table 156. For example, the more congested a zone that is associated with a task, the greater the penalty score that can be assigned to the task. Sometimes, as shown in this illustrative example, the penalty scores can be the same as the congestion scores. Refer to FIG. 8 for further discussion about determining the penalty scores. The weighted scores for the tasks AA-NN can be determined by the computer system 114 based on operational data of the environment 100, lateness ratios of tasks to be completed in the environment 100, the penalty scores, and/or combinations thereof. The weighted scores can be used to rank the tasks AA-NN, determine which of the tasks AA-NN to prioritize, and assign the tasks AA-NN accordingly. Refer to at least FIG. 9 for further discussion.

Still referring to the illustrative example of the tasks table 158, the task BB can include the highest ranked task, even though it is also in the most congested zone in the environment 100. This is because the task type of loading a truck associated with the task BB can be time-consuming, the truck may be behind schedule, additional incoming trucks may need to use a same bay space as the truck associated with the task BB, and/or the task BB is marked as critical or high priority. In some implementations, although not depicted in FIG. 1A, if a task has a penalty score that exceeds some threshold value, then that task may not be assigned right away or can be ranked lower amongst all of the tasks in order to avoid potential safety issues in a congested zone. The task NN can be a lowest-ranked task because it could have a lowest priority tag, is associated with a zone having significant congestion, and/or is ahead of schedule.

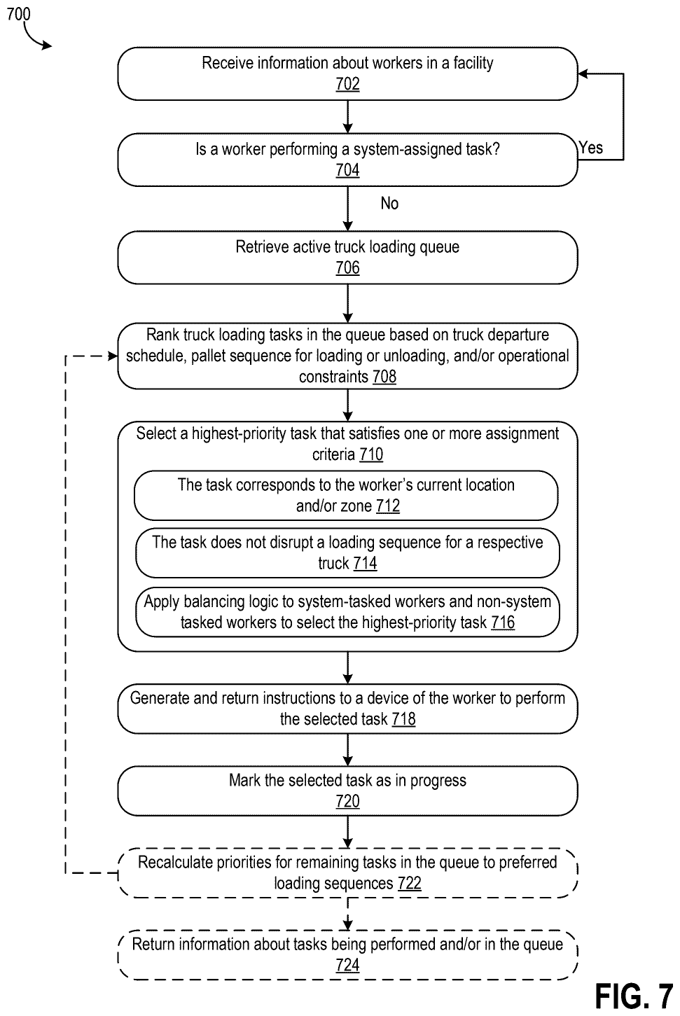

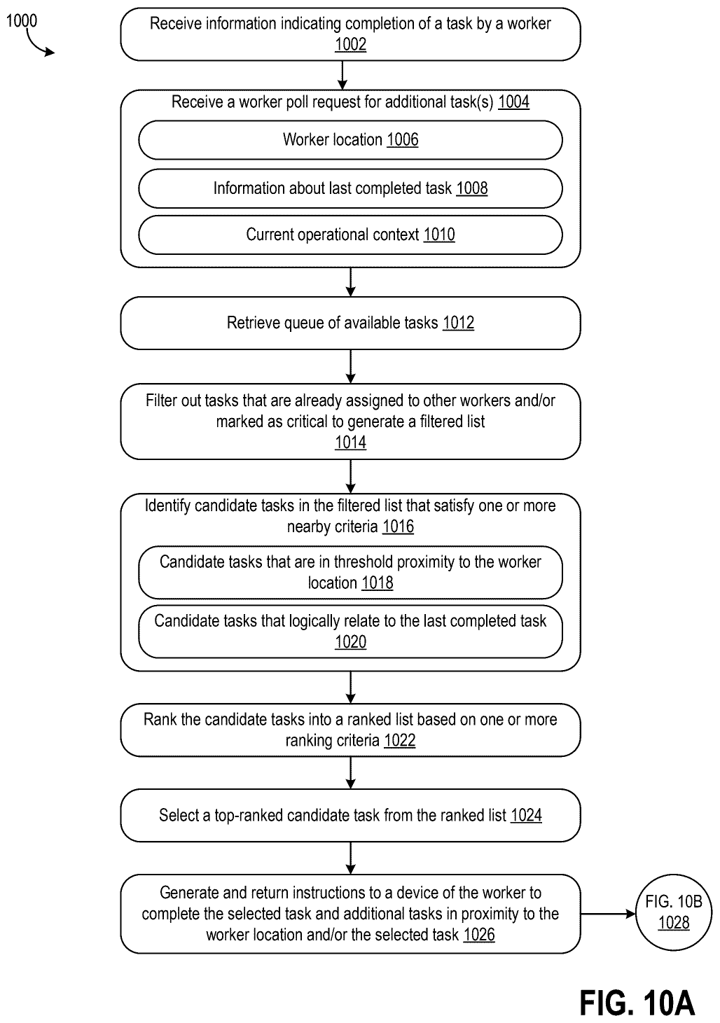

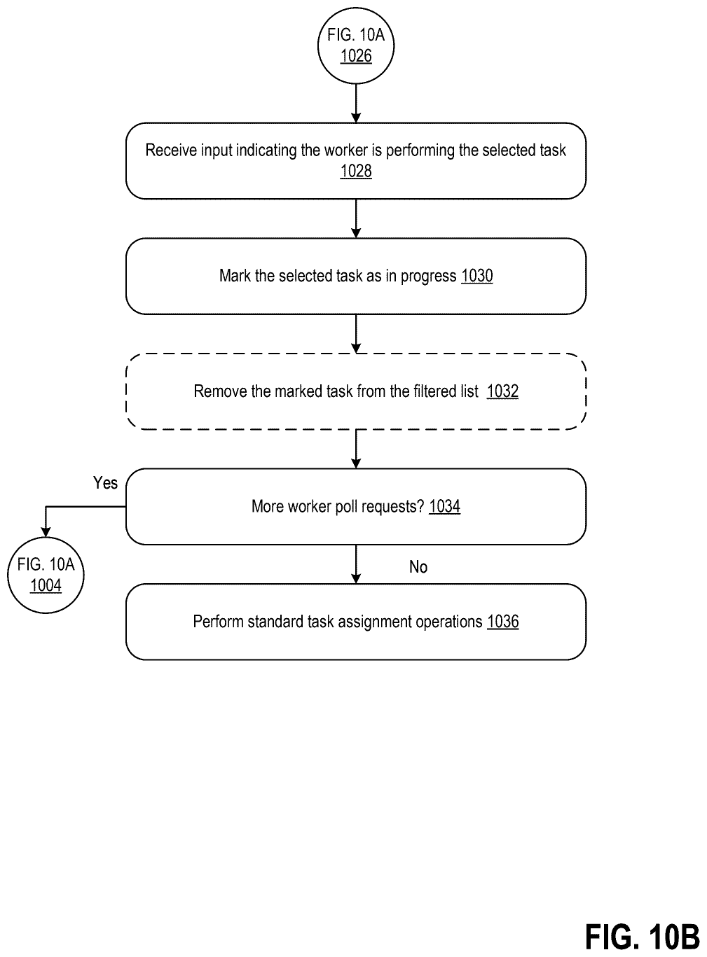

In block C (154), the computer system 114 can assign the tasks AA-NN to the workers, such as the worker W1. As described herein, the worker W1 can be assigned one or more of the tasks AA-NN based at least in part on the information received with their request for tasks and/or the task information in the tasks table 158 (e.g., weighted score, task type, ranking). Various factors can also come into play to determine whether to assign one or more of the tasks AA-NN to the worker W1, including but not limited to the timeliness or lateness of task completions in the environment 100. Refer to FIGS. 7, 10A, and 10B for further discussion about assigning tasks.

The computer system 114 can store or otherwise maintain assignments in an assignments table 160. Among other information, the assignments table 160 can at least indicate workers that are assigned to tasks in the environment 100. In the illustrative example of the assignments table 160, the worker W1 can be assigned to the task AA, even though the task AA is ranked second most important. This is because the worker W1 is within a threshold distance from the task AA and thus can start the task AA before other vehicles or workers may be able to navigate to the zone N. In addition, the zone N has little to no congestion, so it makes sense for the worker W1 to complete the task AA in that zone N before congestion may become an issue. The worker W2 can be assigned multiple tasks, such as the tasks BB and CC. Although both the tasks BB and CC are in the most-congested zone A, the worker W2 is already in that zone, might have been performing similar tasks to the tasks BB and CC, and those tasks BB and CC are highly-ranked. It can also be preferred for the worker W2 to perform both the tasks BB and CC because the worker W2 would have to travel the least amount of distance to perform those tasks and the tasks are sufficiently similar (e.g., task BB can require loading a first pallet onto the truck and task CC can include scanning that first pallet once it is loaded onto the truck). Various other scenarios and/or implementations are also possible and are described further herein.

As described herein, the disclosed technology provides computationally efficient techniques that lower CPU cycles and network chatter. For example, the disclosed technology can reduce or otherwise lower the CPU cycles and/or network bandwidth by at least a threshold amount or level. This threshold reduction in computational resource usage allows the disclosed technology to continue operating and assigning tasks in real-time as information is continuously received and/or updated. In some implementations, the computer system 114 can maintain a priority queue where each of the tasks AA-NN has a dynamic weighted score. The queue can be implemented as a heap in the computer system 114 so that pulling the next best task for assignment can updating the weighted scores of the tasks can be done quickly and efficiently. In the heap, the weighted score can be a heap key for its respective task. In a min-heap, the task with the smallest weighted score can be on top of the heap. On the other hand, in a max-heap, the task with the largest weighted score can be on top of the heap. Heaps advantageously keep the next best task easily accessible without requiring the use of processing or compute power to rescore and resort everything in the heap (e.g., all the tasks AA-NN in the environment 100). Thus, when the weighted score changes, only tasks whose keys (e.g., scores) changed may be updated in the heap, thereby allowing the heap to efficiently bubble them up or down accordingly.

The weighted scores can change and thus be recomputed upon identification of specific events. As a result, only scores for the tasks that are impacted by the specific events can be recomputed. Example events that trigger recomputing can include scanning a pallet (e.g., a worker or scanner confirms pallet state and/or location), door assignments and/or changes (e.g., dock door updates), updates in truck ETAs (e.g., schedule slip or advance), workers moving and/or polling for tasks (e.g., location and/or availability change), and/or task completion (e.g., free dependences, changes local context). Once the tasks or resources are identified that may be impacted by the specific event(s) in the environment 100, the computer system 114 can recompute the weighted score for only the identified task(s) and/or resources (e.g., their heap keys) and then apply heap key updates (e.g., decrease, increase) to reposition the identified task(s) and/or resources in the heap. Other tasks may not be touched, thereby making the heaps and priority updating both incremental and event-driven.

In an illustrative example, the worker W2 in zone A can complete scanning of a pallet associated with the task CC. As a result of this event, the computer system 114 can receive a scan-complete event notification with the worker W2's location and last-task contextual information. The computer system 114 may not recompute all tasks AA-NN. Instead, the computer system 114 can target only candidate tasks that may be physically nearby and/or logically related to the scanned pallet of the task CC (e.g., same truck and/or sequence, similar type of task). For example, the computer system 114 may recompute only the weighted score for the task BB, which is also located in the zone A and can involve a same truck from which the pallet was retrieved and scanned. As a result of readjusting the weighted score for the task BB, the computer system 114 can adjust the rankings of the tasks AA-NN by increasing or decreasing the task BB in the heap. The operations described herein are lightweight, efficient, and accurate, consuming less compute resources and network bandwidth than existing systems.

FIG. 1B is a conceptual diagram of a state of the warehouse environment 100 at initial task assignment. The example warehouse environment 100 shows a current location of various vehicles, such as forklift 104A and 104B, as they move throughout the environment 100. The forklifts 104A-B can be operated by warehouse workers (e.g., operators). The forklifts 104A-B can be assigned tasks to complete in the warehouse environment 100. In some implementations, warehouse workers can also be assigned tasks to complete in the warehouse environment 100 that may or may not include using the forklifts 104A-B.

The warehouse environment 100 can also include various objects that can be moved throughout the environment 100, such as pallets 108A and 108B. The pallets 108A-B can be full pallets that are completely built. The pallets 108A-B can be stored at various locations in the warehouse environment 100. The pallets 108A-B can also be moved to different locations in the warehouse environment 100 while the pallets 108A-B are stored at the warehouse environment 100.

For example, the pallets 108A-B can be received in a docking area 102. The pallets 108A-B can be unloaded from a truck that arrived at the docking area 102. The pallets 108A-B can then be moved into storage in a storage area 106. The pallet 108A can be moved to storage location 122A in the storage area 106. The pallet 108B can be moved to storage location 122N in the storage area 106. The storage locations 122A-N can be bays, racks, or other types of areas for storing items such as the pallets 108A-B. The pallets 108A-B can remain in their respective storage locations 122A-N until the pallets 108A-B are requested by a customer. When requested by the customer, a warehouse worker, such as the forklift 104A can be instructed to pick up the pallets 108A-B and move them to the docking area 102, to be loaded onto an outbound truck. In some implementations, the pallets 108A-B can be moved to different storage locations or areas within the warehouse environment 100. As an illustrative example, the pallet 108A can be stored in the location 122A until the pallet 108A is needed to replenish a pick line bay. The pallet 108A can therefore be retrieved from the location 122A and moved to an area where the pick line bay is located.

The warehouse environment 100 can also include multiple storage areas 106. For example, one or more storage areas can be designated for cold storage. One or more storage areas can be other types of storage rooms or enclosed areas. The example warehouse environment 100 of FIG. 1B includes one storage area 106 having aisles 124A and 124B. Each of the aisles 124A and 124B can be lined with multiple racks, bays, or other storage locations 122A-N. Items such as the pallets 108A-B can be put away and/or picked up from the storage locations 122A-N in the aisles 124A-B.

In order to determine optimal task selection and assignment for the forklifts 104A-B, the forklifts 104A-B can communicate with a computer system 114 via network(s) 116 (e.g., wired and/or wireless communication). The computer system 114 can be configured to determine optimal task selection and assignment for each of the forklifts 104A-B or other warehouse workers, as described herein. In some implementations, the computer system 114 can be part of a warehouse management system (WMS) and/or in communication with the WMS.

At time=0, the computer system 114 can make initial task assignments to the forklifts 104A-B. For example, the computer system 114 can receive requests for tasks from the forklifts 104A-B (step A, 126). In some implementations, the computer system 114 can receive a request for a task from one of the forklifts 104A-B but not both. For example, the forklift 104A can complete a current task and therefore request a new task while the forklift 104B can be still working on a current task and therefore not ready to accept a new task. The forklifts 104A-B can send requests for new tasks when they are available to execute next tasks. For example, the forklifts 104A-B can finish full pallet movement and/or switch task groups.

The computer system 114 can then assign tasks to the forklifts 104A-B (step B, 128). Typically, the warehouse environment 100 can have 0-500 tasks to be performed at any given time. Moreover, the warehouse environment 100 can have between 1-40 warehouse workers, such as the forklifts 104A-B, that can perform the tasks. Optimizing task assignment can therefore be beneficial to improve overall warehouse efficiency in completing the tasks on-time. The tasks can be associated with full pallet moves. Such tasks can include putting away a pallet (e.g., inbound task), staging a pallet (e.g., outbound task), replenishment, reverse replenishment, and relocation. Putting away the pallet can include moving the pallet from a docking area to a storage location. Staging the pallet can include moving the pallet from the storage location to a dock lane, which can be for pre-work or for an active outbound truck. Replenishment can include moving the pallet from the storage location to a pick line location. Reverse replenishment can include moving the pallet from the pick line back to a storage location. Relocation can include moving the pallet from one storage location to another storage location.

The initial task assignments can be represented by initial task assignment table 118 depicted in FIG. 1B. The table 118 can indicate a task, a projected task travel time, a projected empty travel route, and a projected empty travel time per task that is assigned to each of the forklifts 104A-B. The tasks 112A-F can be ready to be performed. In other words, the table 118 can only indicate task assignments that are ready to be performed, not tasks that are about to be ready to be performed. This is advantageous to ensure that task assignments are based on a current state of the warehouse environment.

As depicted and described further below, each of the forklifts 104A-B can be assigned both inbound and outbound tasks. Assigning both types of tasks to each of the forklifts 104A-B can be advantageous because an end location of an inbound task can be close to a start location of an outbound task. As a result, each of the forklifts 104A-B can have less empty travel time between the inbound and outbound task, thereby improving forklift efficiency as well as overall warehouse efficiency.

Assigning the tasks can also include determining, by the computer system 114, efficiency metrics for each of the forklifts 104A-B. Thus, the computer system 114 can generate a time efficiency table 120. The table 120 can indicate a total amount of empty travel time per forklift and a global empty travel time metric for the warehouse environment 100. The table 120 can be generated on the assumption that the forklifts 104A-B complete all of the initial tasks that they are assigned in the table 118.

As depicted in FIG. 1B, the forklift 104A is assigned tasks 112A, 112B, and 112C. The computer system 114 estimates that it can take 5 minutes to complete task 112A (represented by a solid line in the warehouse environment 100), but before the forklift 104A can complete the task 112A, the forklift 104A is projected to spend 1 minute of empty travel time along empty travel route 110A (represented by a dashed line in the warehouse environment 100). Task 112A is an inbound task that requires the forklift 104A to move the pallet 108A from the docking area 102 to the storage location 122A in aisle 124B of the storage area 106. The forklift 104A is projected to take 1 minute to move from its current location in the docking area 102 to a current location of the pallet 108A in the docking area 102. This is the empty travel time, which is assessed by the computer system 114 to determine efficiency of the forklift 104A as well as overall warehouse efficiency. Once at the current location of the pallet 108A, the computer system 114 projects that it will take the forklift 104A 5 minutes to complete moving the pallet 108A to the storage location 122A in the task 112A.

Next, the forklift 104A has been assigned the outbound task 112B. The computer system 114 estimates that it can take the forklift 104A 6 minutes to complete the task 112B, but before the forklift 104A can complete the task 112B, the forklift 104A is projected to spend 1 minute and 30 seconds of empty travel time along empty travel route 110B. In other words, the computer system 114 estimates that it will take the forklift 104A 1 minute and 30 seconds to move along the empty travel route 110B from the storage location 122A (the end location of the task 112A) to a start location 122B of the task 112B. Once at the location 122B, the computer system 114 projects that it will take the forklift 104A 6 minutes to move an item from the location 122B to the docking area 102 in order to complete the task 112B.

Next, the forklift 104A has been assigned the outbound task 112C. The computer system 114 estimates that it can take the forklift 104A 3 minutes to complete the task 112C, but before the forklift 104A can complete the task 112C, the forklift 104A is projected to spend 3 minutes of empty travel time along empty travel route 110C. In other words, the computer system 114 estimates that it will take the forklift 104A 3 minutes to move along the empty travel route 110C from the docking area 102 (the end location of the task 112B) to a start location 122C of the task 112C. Once at the location 122C, the computer system 114 projects that it will take the forklift 104A 3 minutes to move an item from the location 122C back to the docking area 102 in order to complete the task 112C.

Similarly, the forklift 104B is assigned a set of tasks: 112D, 112E, and 112F. The forklift 104B has been assigned the outbound task 112D. The computer system 114 estimates that it can take the forklift 104B 1 minute and 30 seconds to complete the task 112D, but before the forklift 104B can complete the task 112D, the forklift 104B is projected to spend 1 minute and 30 seconds of empty travel time along empty travel route 110D. In other words, the computer system 114 estimates that it will take the forklift 104B 1 minute and 30 seconds to move along the empty travel route 110D from the docking area 102 (a current location of the forklift 104B) to a start location 122D of the task 112D. Once at the location 122D, the computer system 114 projects that it will take the forklift 104B 1 minute and 30 seconds to move an item from the location 122D back to the docking area 102 in order to complete the task 112D.

Next, the forklift 104B has been assigned another outbound task 112E. The computer system 114 estimates that it can take the forklift 104B 3 minutes to complete the task 112E, but before the forklift 104B can complete the task 112E, the forklift 104B is projected to spend 2 minutes of empty travel time along empty travel route 110E. In other words, the computer system 114 estimates that it will take the forklift 104B 2 minutes to move along the empty travel route 110E from the docking area 102 (the end location of the task 112D) to a start location 122E of the task 112E. Once at the location 122E, the computer system 114 projects that it will take the forklift 104B 3 minutes to move an item from the location 122E back to the docking area 102 in order to complete the task 112E.

Finally, the forklift 104B has been assigned inbound task 112F. The computer system 114 estimates that it can take the forklift 104B 4 minutes to complete the task 112F, but before the forklift 104B can complete the task 112F, the forklift 104B is projected to spend 1 minute of empty travel time along empty travel route 110F. In other words, the computer system 114 estimates that it will take the forklift 104B 1 minute to move along the empty travel route 110F from the docking area 102 (the end location of the task 112E) to a current location of the pallet 108B in the docking area 102. Once at the current location of the pallet 108B, the computer system 114 projects that it will take the forklift 104B 4 minutes to move the pallet 108B to the storage location 122N in order to complete the task 112F.

The time efficiency table 120, as described above, indicates the total empty travel time of each of the forklifts 104A-B. Thus, if the forklift 104A completes the tasks 112A-C in the order designated by the initial task assignment table 118, the forklift 104A is projected to have 5 minutes and 30 seconds of empty travel time. This time is a measure of the forklift 104A's inefficiency. If the forklift 104B completes the tasks 112D-F in the order designated by the table 118, then the forklift 104B is projected to have 4 minutes and 30 seconds of empty travel time. This is also a measure of the forklift 104B's inefficiency. Finally, the global empty travel time for the warehouse environment 100 is projected to be 10 minutes, which is a combination of the empty travel time of the forklift 104A and the empty travel time of the forklift 104B. The global empty travel time is a measure of the overall warehouse environment 100's inefficiency.

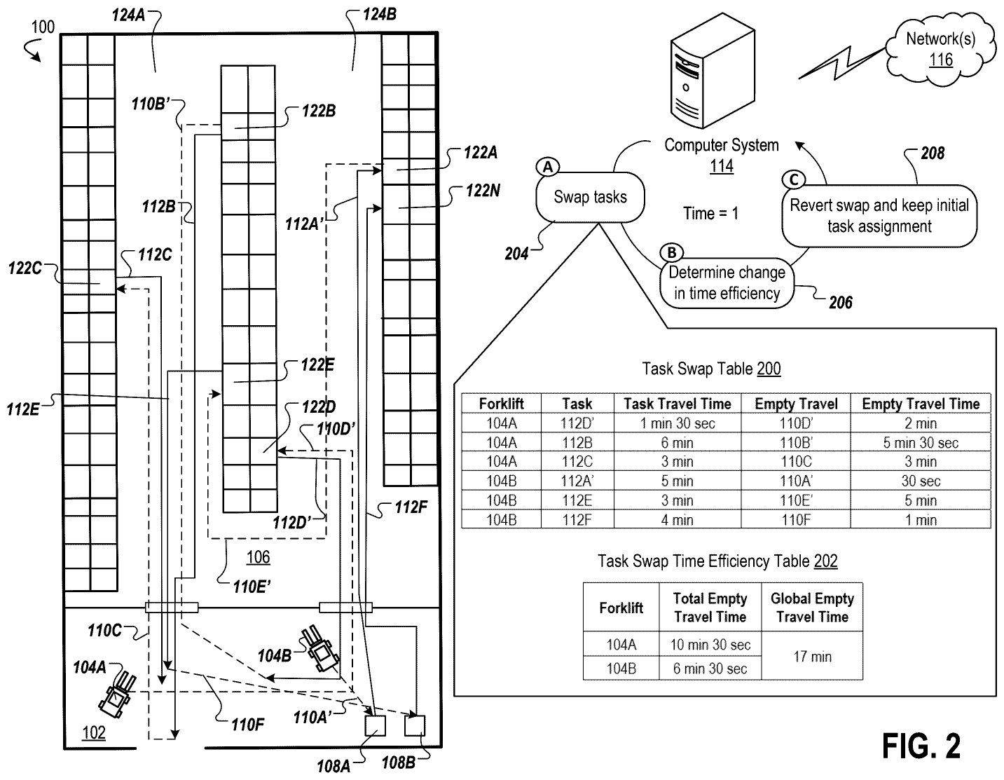

FIG. 2 is a conceptual diagram of a state of the warehouse environment 100 after a first swap of task assignments. Although one swap is depicted in FIG. 2, multiple swaps can be performed by the computing system 114 at a given time. The computing system 114 can perform multiple swaps at a time (e.g., every second) in order to keep up with how fast a state of the warehouse environment 100 can change. Thus, a most optimal task swap and selection can be made in a short period of time.

At time=1, the computer system 114 can swap tasks (step A, 204). In other words, the computer system 114 can assign a task to be completed by the forklift 104B to the forklift 104A and vice versa. In some implementations, the computer system 114 can swap destinations for completing one or more tasks that are assigned to one or more of the forklifts 104A-B. The computer system 114 can also swap source items/pallets for completing one or more tasks that are assigned to one or more of the forklifts 104A-B. In some implementations, the computer system 114 can swap first tasks that are assigned to each of the forklifts 104A-B. In some implementations, the computer system 114 can randomly select which tasks to swap between the forklifts 104A-B. Thus, inbound tasks can be swapped with inbound tasks, outbound tasks can be swapped with outbound tasks, and inbound tasks can be swapped with outbound tasks.

When choosing which tasks to swap, the computer system 114 can first determine whether it is feasible for either of the forklifts 104A-B to perform the swapped tasks. For example, the computer system 114 can determine whether the forklift 104B has necessary equipment to complete a task that would have been completed by the forklift 104A (e.g., forklifts can complete tasks on different storage levels in the storage area 106 while a warehouse jack may only be able to complete tasks on low storage levels in the storage area 106). If the forklift 104B does have the necessary equipment to complete the task, then the computer system 114 can continue to assess whether implementing the swap can result in an improvement of global efficiency and forklift efficiency.

Once the computer system 114 swaps the tasks, the computer system 114 can determine a change in time efficiency for each of the forklifts 104A-B (step B, 206). Based on the change in time efficiency, the computer system 114 can determine whether swapping the tasks resulted in an improvement on global warehouse and/or forklift efficiency.

As shown in FIG. 2, the computer system 114 can revert the swap and keep the initial task assignments (step C, 208). The computer system 114 can make this determination when the change in time efficiency for each of the forklifts 104A-B is not an improvement from the time efficiency metrics that were projected for the initial task assignments.

In the example of FIG. 2, task swap table 200 demonstrates a swap made by the computer system 114. The computer system 114 assigned the forklift 104A task 112D′, which was the task 112D initially assigned to the forklift 104B (refer to FIG. 1B). The computer system 114 assigned the forklift 104B task 112A′, which was the task 112A initially assigned to the forklift 104A (refer to FIG. 1B). Based on this swap, the computer system 114 projected that the forklift 104A can complete the task 112D′ in 1 minute 30 seconds, but will experience 2 minutes of empty travel time along empty travel route 110D′. In the initial task assignment depicted in FIG. 1B, the computer system 114 had projected that the forklift 104B could complete the task 112D in 1 minute and 30 seconds with 1 minute and 30 seconds of empty travel time along the empty travel route 110D. Thus, the computer system 114 can determine that it is more efficient to revert the swap back to the initial task assignment since the forklift 104B can complete the task 112D with 30 seconds less of empty travel time than the forklift 104A.

The computer system 114 also projected that based on the swap, the forklift 104A can complete the originally assigned task 112B next in 6 minutes. However, the computer system 114 projected that the forklift 104A can experience 5 minutes and 30 seconds of empty travel time along empty travel route 110B′ in order to complete the task 112B. In the initial task assignment depicted in FIG. 1B, the computer system had projected that the forklift 104A could complete the task 112B in 6 minutes and experience only 1 minute and 30 seconds of empty travel time along the empty travel route 110B. Thus, the computer system 114 can determine that it is more efficient to revert the swap back to the initial task assignment since the forklift 104A can complete the task 112B with 4 minutes less of empty travel time when the task 112B follows the initial task 112A.

Similarly, based on the swap, the computer system 114 projected that the forklift 104B can complete the task 112A′ in 5 minutes, but will experience 30 seconds of empty travel time along empty travel route 110A′. In the initial task assignment depicted in FIG. 1B, the computer system had projected that the forklift 104A could complete the task 112A in 5 minutes with 1 minute of empty travel time along the empty travel route 110A. Thus, the computer system 114 can determine that it may be efficient to keep the swap since the forklift 104B can complete the task 112A′ with 30 seconds of empty travel time along the empty travel route 110A′. Regardless, when the 30 seconds of empty travel time is combined with the other empty travel times to determine a total empty travel time for the forklift 104B based on the swap, the total empty travel time for the forklift 104B may not be improved.

The computer system 114 also projected that based on the swap, the forklift 104B can complete the originally assigned task 112E next in 3 minutes. However, the computer system 114 projected that the forklift 104B can experience 5 minutes of empty travel time along empty travel route 110E′ in order to complete the task 112E. In the initial task assignment depicted in FIG. 1B, the computer system had projected that the forklift 104B could complete the task 112E in 3 minutes and experience 2 minutes of empty travel time along the empty travel route 112E. Thus, the computer system 114 can determine that although the forklift 104B can complete the task 112E in 3 minutes whether or not the tasks are swapped, the forklift 104B can experience 3 more minutes of empty travel time along the empty travel route 110E′. Therefore, swapping the tasks may not be efficient.

Based on the swap, the computer system 114 can also generate a task swap time efficiency table 202. The table 202 can indicate projected total empty travel time per forklift based on the swap. The table 202 also indicates projected global empty travel time for the warehouse environment 100. Based on assigning the forklift 104A the task 112D′ and assigning the forklift 104B the task 112A′, the forklift 104A is projected to experience a total of 10 minutes and 30 seconds of empty travel time. Under the initial task assignments depicted in FIG. 1B, the forklift 104A was only expected to experience 5 minutes and 30 seconds of empty travel time. Thus, the swap would cause the forklift 104A to experience 5 more minutes of empty travel time, which is an indication of increased inefficiency resulting from the swap.

The forklift 104B is projected to experience a total of 6 minutes and 30 seconds of empty travel time based on the swap. Under the initial task assignments depicted in FIG. 1B, the forklift 104B was expected to experience 4 minutes and 30 seconds of empty travel time. Thus, the swap would cause the forklift 104B to experience 2 more minutes of empty travel time, which is an indication of increased inefficiency resulting from the swap.

Finally, the projected global empty travel time for the warehouse environment 100 amounts to 17 minutes based on the swap. Under the initial task assignments depicted in FIG. 1B, the projected global empty travel time was 10 minutes. Thus, the swap would cause increased inefficiency in the overall warehouse environment 100.

Based on such analysis and as described above, the computer system 114 can revert the swap and keep the initial task assignments (step C, 208).

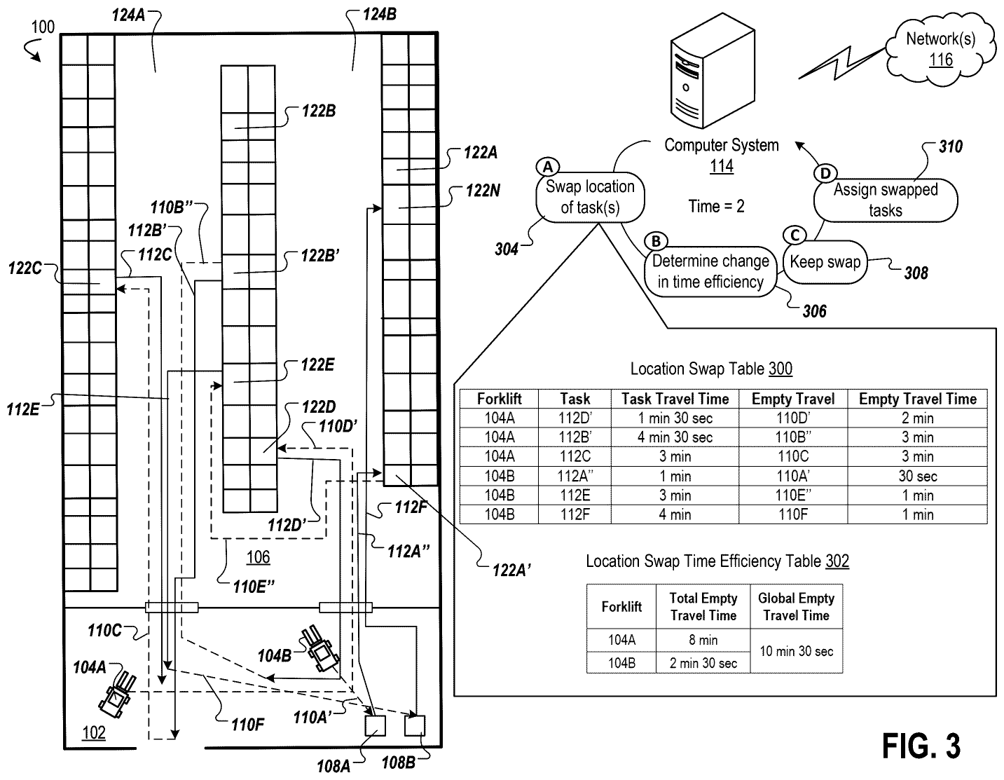

FIG. 3 is a conceptual diagram of a state of the warehouse environment 100 after a second swap of task assignments. At time=2, the computer system 114 can swap location(s) of task(s) (step A, 304). Not only did the computer system 114 assign task 112D′ to forklift 104A, the computer system 114 also changed a location of the original task 112B, thereby modifying the original task 112B to task 112B′. The computer system 114 also assigned the original task 112A to the forklift 104B and changed a location of the original task 112A, thereby modifying the original task 112A to task 112A″. The swaps made by the computer system 114 are depicted in location swap table 300.

Once the computer system 114 swaps the tasks, the computer system 114 can determine a change in time efficiency for each of the forklifts 104A-B (step B, 306). Based on the change in time efficiency, the computer system 114 can determine whether swapping the tasks resulted in an improvement on global warehouse and/or forklift efficiency.

As shown in FIG. 3, the computer system 114 can keep the swap (step C, 308). The computer system 114 can make this determination when the change in time efficiency for each of the forklifts 104A-B is improved from the time efficiency metrics that were projected for the initial task assignments and/or any previous swaps. Moreover, the computer system 114 can assign the swapped tasks to each of the forklifts 104A-B (step D, 310).

Based on the example swap in FIG. 3, the computer system 114 projected that the forklift 104A can complete the task 112D′ in 1 minute 30 seconds, but will experience 2 minutes of empty travel time along empty travel route 110D′. In the first attempted swap depicted in FIG. 2, the computer system 114 had projected that the forklift 104B could complete the task 112D′ in 1 minute and 30 seconds with 2 minutes of empty travel time along the empty travel route 110D′. Thus, the computer system 114 can determine that there is no improvement in efficiency with the swap of FIG. 3.

The computer system 114 also projected that based on changing the task 112B′ location from 122B to 122B′, the forklift 104A can complete the task 112B′ in 4 minutes and 30 seconds and experience 3 minutes of empty travel time along the empty travel route 110B″. In the first attempted swap depicted in FIG. 2, the computer system 114 projected that the forklift 104A could complete the task 112B in 6 minutes and experience 5 minutes and 30 seconds of empty travel time along the empty travel route 110B. The computer system 114 can therefore determine that changing the task 112B′ location from 122B to 122B′ resulted in saving the forklift 104A 2 minutes and 30 seconds in empty travel time. Thus, efficiency of the forklift 104A improved from the swap in FIG. 3.

Additionally, based on assigning the task 112A″ to the forklift 104B and changing the task 112A″ location from 122A to 122A′, the forklift 104B can complete the task 112A″ in 1 minute and experience 30 seconds of empty travel time along empty travel route 110A′. In the first attempted swap depicted in FIG. 2, the computer system 114 projected that the forklift 104B could complete the task 112A′ in 5 minutes and experience 30 seconds of empty travel time along the empty travel route 110A′. Although the empty travel time is the same in both swaps, the computer system 114 can determine that the swap in FIG. 3 is better than the swap in FIG. 2 because the forklift 104B can complete the task 112A″ in 3 minutes and 30 seconds less time than completing the task 112A′. Thus, changing or swapping the destination location of the task 112A″ from location 122A to location 122A′ improved efficiency of the forklift 104B.

Based on changing the destination location 122A′ for the task 112A″, the computer system 114 also projected that the forklift 104B can complete the task 112E in 3 minutes and experience 1 minute of empty travel time along empty travel route 110E″. In the first attempted swap depicted in FIG. 2, the computer system 114 projected that the forklift 104B could complete the task 112E in 3 minutes and experience 5 minutes of empty travel time along the empty travel route 110E′. The long amount of empty travel time is because the forklift 104B would have to travel from location 122A in aisle 124B to location 122B in aisle 124A. By changing the destination location of the task 112A″ to the location 122A′, the forklift 104B can complete the task 112E with 4 minutes less of empty travel time along the empty travel route 110E″. This is because the location 122A′ is closer to the location 122E of the task 112E. Thus, the computer system 114 can determine that changing the location of the task 112A″ resulted in improved efficiency for the forklift 104B to complete the task 112E.

Based on the swaps discussed above in reference to FIG. 3, the computer system 114 can generate a location swap time efficiency table 302. The table 302 can indicate projected total empty travel time per forklift based on the swap. The table 302 also indicates projected global empty travel time for the warehouse environment 100. Based on the swaps discussed in FIG. 3, the forklift 104A is projected to experience a total of 8 minutes of empty travel time. Under the first attempted swap in FIG. 2, the forklift 104A was projected to experience 10 minutes and 30 seconds of empty travel time. Thus, the swaps in FIG. 3 would cause the forklift 104A to be more efficient in completing tasks by 1 minute and 30 seconds.

The forklift 104B is projected to experience a total of 2 minutes and 30 seconds of empty travel time based on the swaps of FIG. 3. Under the first attempted swap in FIG. 2, the forklift 104B was projected to experience 6 minutes and 30 seconds of empty travel time. Thus, the swaps in FIG. 3 would cause the forklift 104B to be more efficient in completing tasks by 4 minutes.

Finally, the projected global empty travel time for the warehouse environment 100 amounts to 10 minutes and 30 seconds based on the swaps in FIG. 3. Under the first attempted swap in FIG. 2, the global empty travel time was projected to be 17 minutes. Thus, the swaps in FIG. 3 can improve overall warehouse efficiency.

Based on such analysis and as described above, the computer system 114 can keep the swaps in FIG. 3 and assign the swapped tasks to the forklifts 104A-N(steps C-D, 308-310).

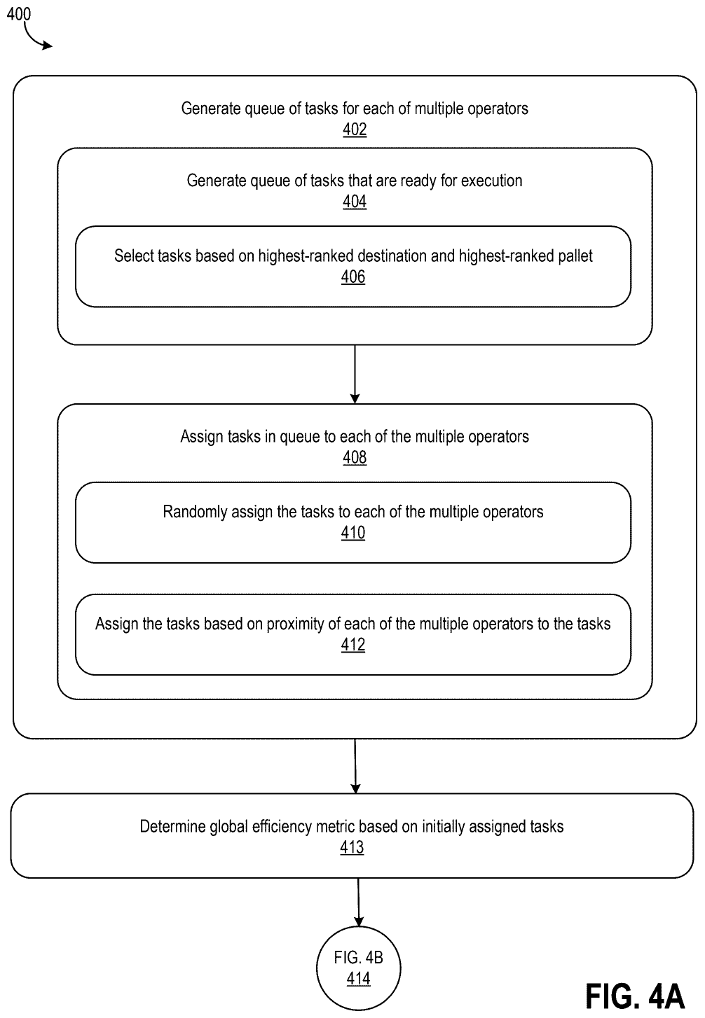

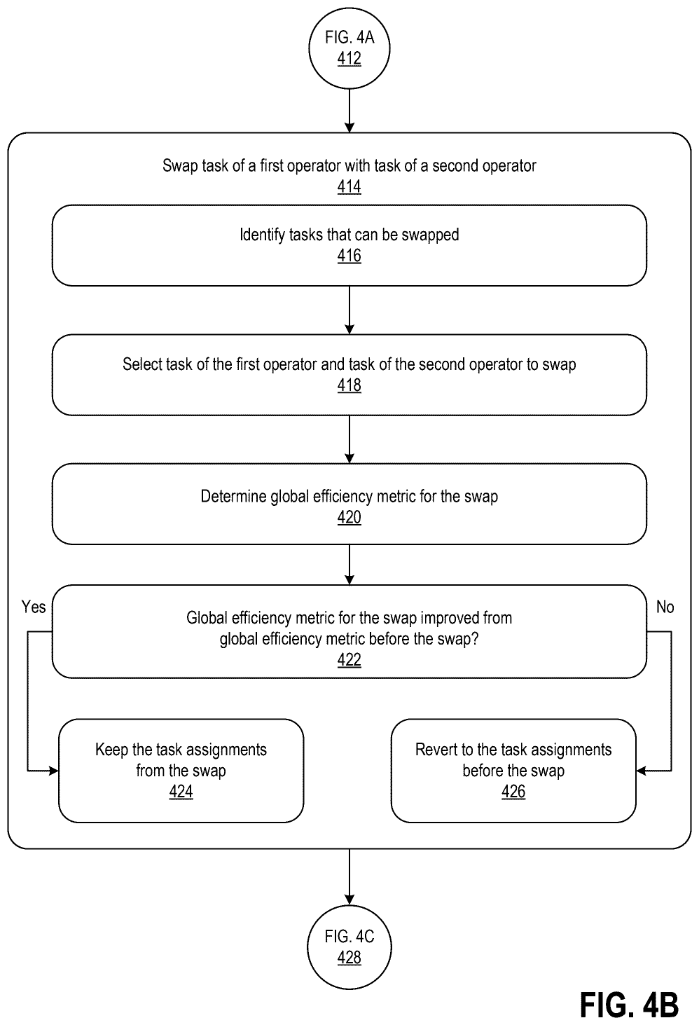

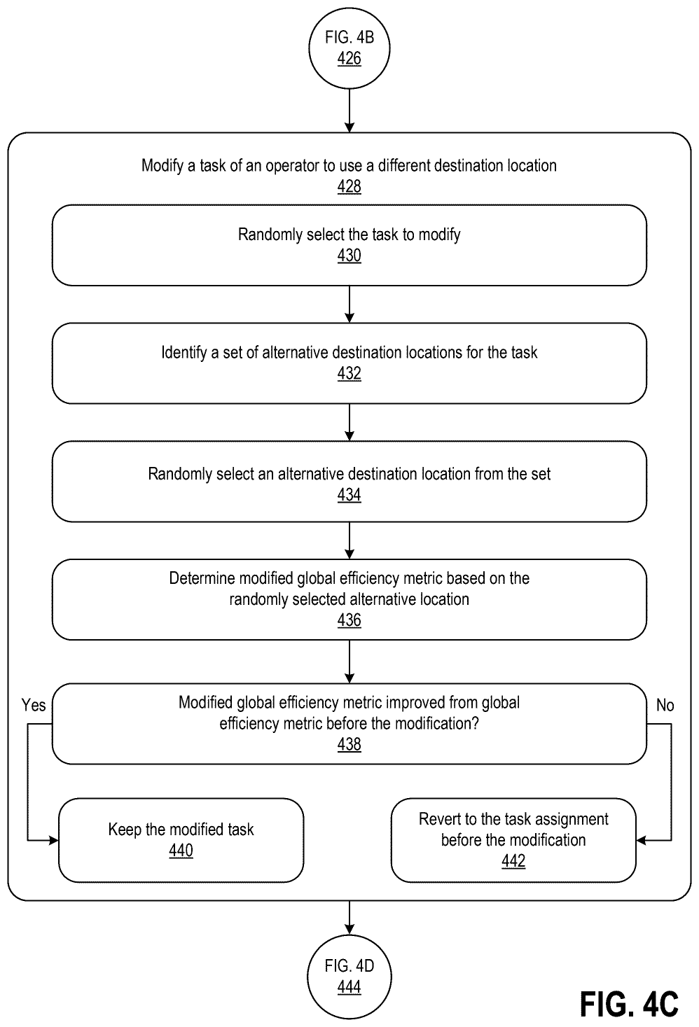

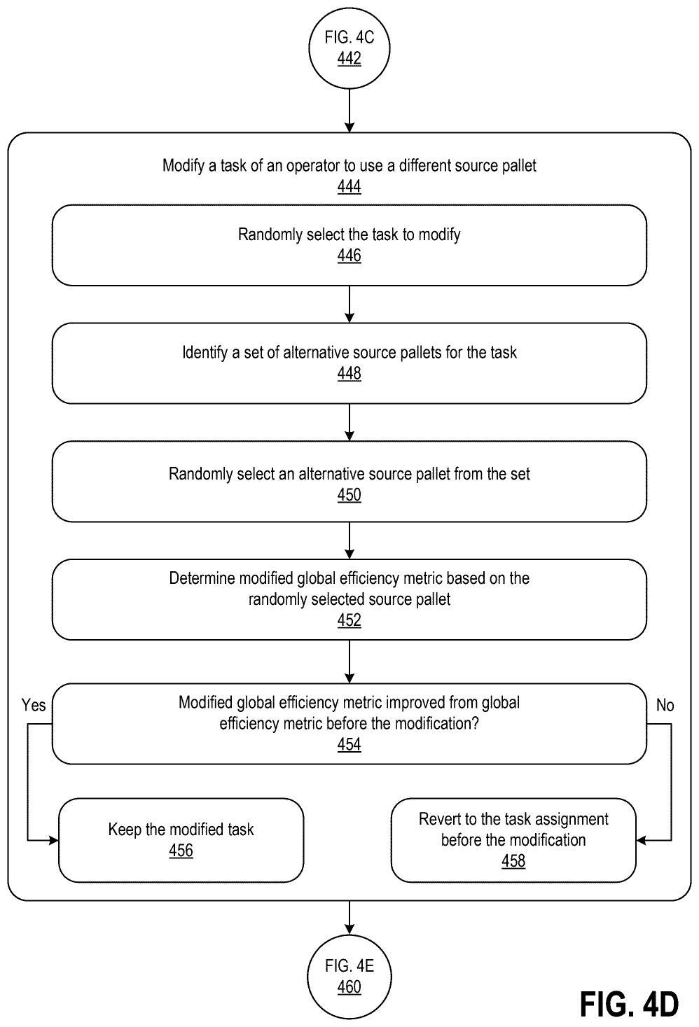

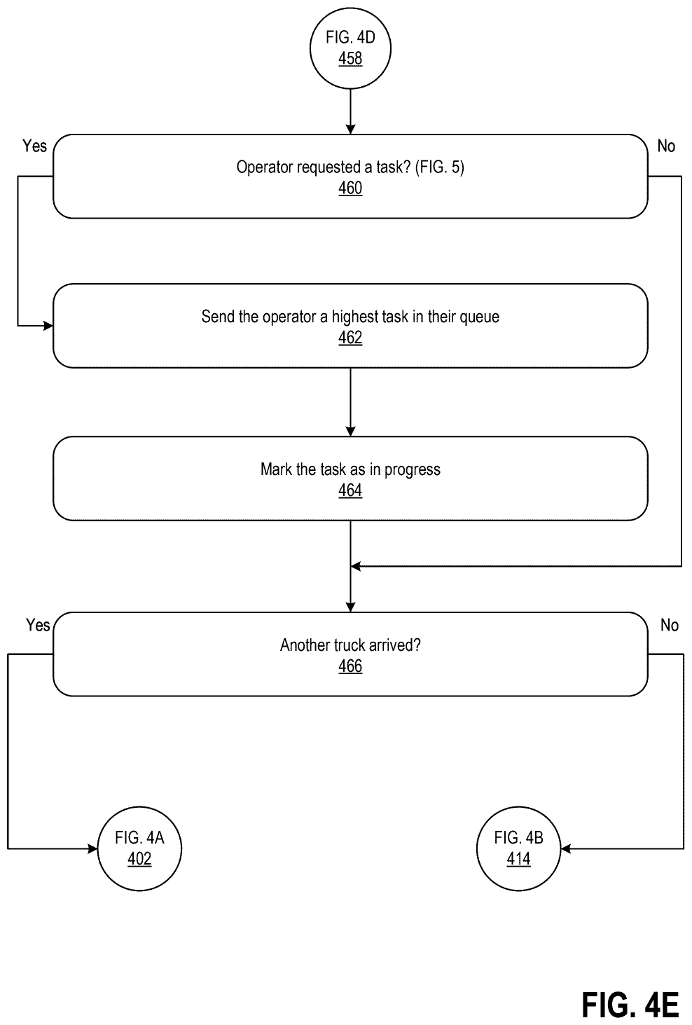

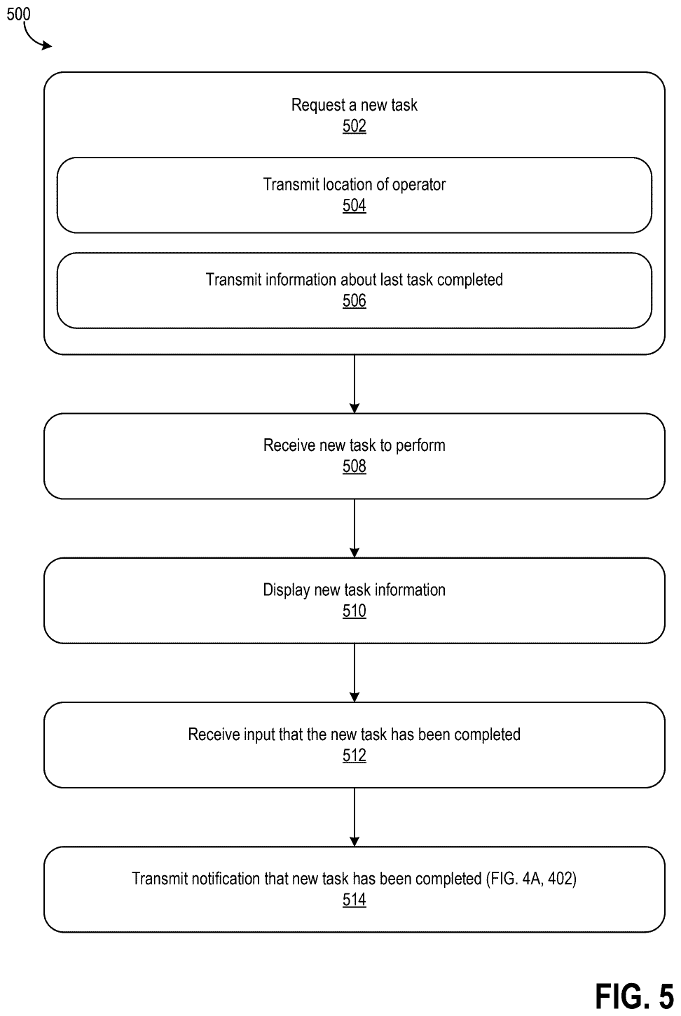

FIGS. 4A-E is a flowchart of a process 400 for determining an optimal task selection for a warehouse operator. The process 400 can be performed by the computer system 114. The process 400 can also be performed by one or more other computer systems, servers, and/or networks of devices. For illustrative purposes, the process 400 is described in reference to a computer system.

Referring to the process 400 in FIGS. 4A-E, the computer system can generate a queue of tasks for each of multiple operators in 402. As described herein, the operators can be warehouse workers, forklifts, and/or other warehouse vehicles that can be used to perform tasks and operations in the warehouse. Moreover, as described herein, the tasks can be associated with a docking area, full pallet movements, and/or case picking.

The computer system can generate a list of tasks that are ready for execution in 404. The computer system can identify a collection of item-movement tasks to perform in the warehouse (e.g., a storage facility). Each item-movement task in the collection of item-movement tasks can indicate movement of a respective item from a respective source location to a respective destination location. For example, the respective item can be a full pallet. The source location of the full pallet can be a docking area and the destination location can be a bay or rack in a storage area where the full pallet is to be stored. This example task can be a put away or inbound task. Generating the list of tasks also includes determining whether the tasks are feasible to be executed at a current time. The tasks can be feasible for execution if, for example, source and/or destination locations associated with the tasks are currently available/accessible. A task can also be feasible for current execution if a pallet for that task is not currently blocked or otherwise inaccessible.

The computer system can also select tasks based on highest-ranked destination and highest-ranked pallet in 406. The highest-ranked destination can be used for inbound or put away tasks. The highest-ranked pallet can be used for outbound or pull tasks. The highest-ranked destination and/or the highest-ranked pallet can indicate an importance or immediacy to perform the associated tasks. For example, a first pallet that arrived at the docking area can have a highest-ranked destination because the first pallet can require cold storage. The longer the first pallet remains in the docking area, the more likely items on the first pallet can spoil or melt. Thus, the first pallet can be selected for the queue as a having the highest-ranked destination. As another example, a second pallet in storage can be designated as a highest-ranked pallet because it can part of a customer pick order that needs to be fulfilled within a threshold period of time. The threshold period of time can be running out, which means the second pallet may need to be pulled from storage immediately. Thus, the second pallet can be selected for the queue as being the highest-ranked pallet. The tasks that are selected based on highest-ranked destination and/or highest-ranked pallet can be slotted at a top of the queues for each of the multiple operators.

As part of generating the queue of tasks for each of the multiple operators, the computer system can assign tasks in the list to each of the multiple operators in 408. The computer system can distribute item-movement tasks in the collection of item-movement tasks among multiple queues of item-movement tasks corresponding to multiple moving machines (e.g., warehouse operators), to form a first state of the multiple queues of item-movement tasks. Each moving machine of the multiple moving machines can have a respective queue of item-movement tasks to perform. For example, a first moving machine of the multiple moving machines can have a first queue of item-movement tasks from among the multiple queues of item-movement tasks, and a second moving machine of the multiple moving machines can have a second queue of item-movement tasks from among the multiple queues of item-movement tasks.

When assigning the tasks to each of the multiple operators in 408, the computer system can determine whether the operators have the capability to perform the tasks. For example, a forklift can reach higher levels in the warehouse than a human worker or a warehouse jack. Thus, tasks that may require accessing higher levels in the warehouse can be assigned to operators having equipment such as forklifts that can access the higher levels. As another example, tasks that require minimum movement on a floor of the warehouse can be assigned to operators who are walking around the warehouse by foot, whereas tasks that require greater movement and distance to cover in the warehouse can be assigned to operators having forklifts.

In some implementations, the computer system can randomly assign the tasks to each of the multiple operators in 410. Such random assignments can still take into consideration whether the operator has the necessary equipment to complete the tasks.

The computer system can also assign the tasks based on proximity of each of the multiple operators to the tasks in 412. For example, the computer system can receive, from the operator, a current location of the operator. The computer system can compare the current location of the operator to start locations of tasks that need to be assigned. The computer system can then assign, to that operator, a task having the closest start location to the current location of the operator.

Once the computer system generates the queues of tasks for each of the multiple operators in 402-412, the computer system can determine a global efficiency metric for the warehouse as well as each of the operators based on the initially assigned tasks (413). In other words, the computer system can determine a first value that indicates utilization of the multiple moving machines. The first value can be based on the multiple moving machines performing the multiple queues of item-movement tasks while the multiple queues of item-movement tasks have the first state. The global efficiency metric, as described herein, can be a measure of how efficiently the operators are utilized. The global efficiency metric can be an amount of empty time that is spent, in aggregate, by the operators moving between tasks in the operators' queues of tasks (e.g., refer to FIGS. 1-3).

Next, the computer system can swap a task of a first operator with a task of a second operator in 414. Thus, the computer system can swap a first item-movement task from the first queue of item-movement tasks with a second item-movement task from the second queue of item-movement tasks, to form a second state of the multiple queues of item-movement tasks. As a result, the first queue of item-movement tasks that can be performed by the first moving machine no longer includes the first item-movement task but now includes the second item-movement task. The second queue of item-movement tasks to be performed by the second moving machine may no longer include the second item-movement task but now may include the first item-movement task. In some implementations, the computer system can swap tasks in a queue of a single operator instead of or in combination with swapping tasks between the first queue of the first operator and the second queue of the second operator.

As part of swapping tasks, the computer system can identify tasks that can be swapped in 416. For example, the computer system can determine whether tasks are currently in progress or ready for execution. The computer system can also determine whether a first task of the first operator can be performed by the second operator based on whether the second operator has the necessary equipment to complete the first task. As an illustrative example, the first task can require an operator to place a pallet on a third level of a rack in the storage area. The first task can be initially assigned to the first operator, which has an appropriate lift truck to store the pallet on the third level of the rack. The first task cannot be swapped with a task of the second operator, however, because the second operator may have a pallet jack. The pallet jack may only lift the pallet to a certain height that is less than the third level of the rack where the pallet for the first task needs to be placed. Thus, the computer system can determine that the first task of the first operator cannot be swapped with a task of the second operator.

The computer system can select the task of the first operator and the task of the second operator to swap in 418. For example, the computer system can select a first task in each of the queues of the first and second operators to swap. The computer system can also select a first task in the queue of the first operator and a second task in the queue of the second operator to swap. The computer system can make any random selection of tasks to swap from the queues of the first and second operators. In some implementations, the tasks can be randomly selected from the queues of the first and second operators. In some implementations, block 418 can be optional.

The computer system can then determine a global efficiency metric for the queues after the swap in 420. The computer system can determine a second value that indicates utilization of the multiple moving machines based on the multiple moving machines performing the multiple queues of item-movement tasks while the multiple queues of item-movement tasks have the second state. The first value that indicates utilization of the multiple moving machines can indicate a first amount that the multiple moving machines are without an item (e.g., empty travel time) to move during performance of the multiple queues of item-movement tasks while the multiple queues of item-movement tasks have the first state. The second value that indicates utilization of the multiple moving machines can indicate a second amount that the multiple moving machines are without an item to move during performance of the multiple queues of item-movement tasks while the multiple queues of item-movement tasks have the second state.

As described throughout, the global efficiency metric can comprise a measure of how much empty travel time exists for each of the operators in between performing tasks that have been swapped. Thus, the computer system can project how much empty travel time the first operator can experience between a first task and a second task, wherein the second task was originally assigned to the second operator. The computer system can also project how much empty travel time the second operator can experience between a third task and a fourth task, wherein the fourth task was originally assigned to the first operator. Thus, the computer system could have swapped the second and fourth tasks between the first and second operators. The computer system can combine the projected empty travel times of the first and second operators in order to determine the global efficiency metric, which can indicate a total amount of empty travel time for the warehouse based on the swapped tasks. The global efficiency metric can be an indicator of how efficiently the warehouse is operating.

The computer system can determine whether the global efficiency metric of the swap improved from a global efficiency metric before the swap (e.g., the global efficiency metric of the initial task assignments in 413) in 422. The global efficiency metric of the swap can improve if in aggregate, the operators are spending less empty travel time between the swapped tasks than the operators were spending between the initially assigned tasks. In some implementations, the efficiency of the first operator can improve from the task swap but the efficiency of the second operator may not improve. Such changes in efficiency may or may not have an impact on the overall global efficiency metric for the warehouse. It can be desired to achieve an overall decrease in empty travel time for the warehouse, which can indicate overall improved efficiency for the warehouse.

In some implementations, the computer system can also set an overdue penalty to the swapped tasks in order to incentivize the tasks to be completed quickly. Thus, the tasks can be required to be completed within maximum timeframes, such as 2 hour windows. The maximum timeframe can be dynamically determined based on a type of task and/or a type of item associated with the task. For example, inbound tasks for pallets that need to be refrigerated can have smaller maximum timeframes for completion than inbound tasks for pallets that have no storage restraints. After all, the pallets requiring refrigeration may melt or spoil if not properly stored in a cold storage area within the maximum timeframe.

A penalty can be assigned to the operator if it takes the operator more than the maximum timeframe to complete the task. Each minute over the maximum timeframe can be penalized as a square of that minute. One or more other quadratic equations or offset values can be used to determine the penalty. In some implementations, the penalty can be applied at a 2 hour mark of the maximum timeframe. The penalty can then be increased as a square of the penalty for every extra minute over the 2 hour mark. The penalty is a weight that can then be applied to the empty travel time for each of the operators. Thus, where the operator does not complete a task within the maximum timeframe, the operator's efficiency metric can decrease because the operator is not efficient in completing tasks.

If the global efficiency metric of the swap is improved, then the computer system can keep the task assignments from the swap in 424. The computer system can leave the multiple queues of item-movement tasks in the second state as a result of determining, based on comparison of the first value to the second value, that utilization of the multiple moving machines is greater when the multiple queues of item-movement tasks have the second state. In other words, the computer system can determine that the swap resulted in improved utilization of resources in comparison to the initial task assignments. One or more of the first and second operators can be spending less empty travel time between tasks. As a result, the global efficiency metric for the warehouse can improve.

If the global efficiency metric of the swap is not improved, then the computer system can revert to the task assignments before the swap in 426. The computer system can determine, based on comparison of the first value to the second value, that utilization of the multiple moving machines is greater when the multiple queues of item-movement tasks have the first state. As a result, the computer system can swap, based on determining that utilization of the multiple moving machines is greater when the multiple queues of item-movement tasks have the first state, the first item-movement task in the second queue of item-movement tasks with the second item-movement task in the first queue of item-movement tasks, to revert the multiple queues of item-movement tasks to the first state.

In addition to swapping the tasks in 414-426, the computer system can modify a task of an operator to use a different destination location in 428 (e.g., refer to FIG. 3). For example, the computer system can change a destination location for a put away pallet or inbound task. The computer system can also change a source pallet for a pull task or outbound task. The computer system can determine a third value that indicates utilization of the multiple moving machines based on the multiple moving machines performing the multiple queues of item-movement tasks while the multiple queues of item-movement tasks have a third state. The computer system can also modify a third item-movement task from the first queue of item-movement tasks while the multiple queues of item-movement tasks have the third state (i) from having an original destination location at which to place an item to be moved by the third-item-movement task (ii) to having an alternative destination location at which to place the item to be moved by the third item-movement task, to form a fourth state of the multiple queues of item-movement tasks.

As part of modifying the task to use the different destination location, the computer system can randomly select the task to modify in 430. For example, the computer system can randomly select a task from a queue of a first operator. In some implementations, the computer system can select a highest-ranked task from the queue of the first operator.

The computer system can identify a set of alternative destination locations for the selected task in 432. The set of alternative destination locations can include locations that are currently available. The set of alternative destination locations may not include locations that are currently being used in a task. For example, if a task is in progress at a first alternative destination location, then the computer system may not identify that first alternative destination location in the set for the selected task. The set of alternative destination locations may also include locations that satisfy any storage conditions for the selected task. For example, if the selected task involves storing a pallet in cold storage, then the computer system may only identify alternative destination locations that are in cold storage. As another example, the computer system can identify alternative destination locations that satisfy other storage conditions, such as size and weight dimensions for the selected task.

Moreover, the computer system can identify alternative destination locations that can be accessed by the operator who is assigned to the selected task. For example, if the operator drives a lift truck, then the alternative destination locations can be multiple levels off the ground since the lift truck can access the higher levels. On the other hand, if the operator operates a pallet jack, then the alternative destination locations can be on a first level with the ground since the pallet jack can only raise a pallet so high. As yet another example, if the operator is walking around the warehouse, then the alternative destination locations can be locations on the ground level of the warehouse that are not too great of distances for the operator to walk to while carrying the pallet or item(s).

The computer system can randomly select an alternative destination location from the set in 434. In some implementations, the computer system can select a highest ranked alternative destination location. In some implementations, the computer system can select an alternative destination location that is closest to a current location of the operator.

The computer system can then determine a modified global efficiency metric based on the randomly selected alternative location in 436. The computer system can determine a fourth value that indicates utilization of the multiple moving machines based on the multiple moving machines performing the multiple queues of item-movement tasks while the multiple queues of item-movement tasks have the fourth state. The fourth state, as described above, can be when a scenario when the alternative destination location is selected from the set of alternative destination locations. In other words, the computer system can determine how much empty travel time the operator may experience by performing the task with the selected alternative destination location.

The computer system can determine whether the modified global efficiency metric improved from a global efficiency metric before the modification in 438. As described above, the computer system can determine whether selecting the alternative destination location reduced the empty travel time for the operator and/or aggregate empty travel time for the warehouse.

If the modified global efficiency metric is improved, then the modified task can be kept in 440. For example, the computer system can leave the multiple queues of item-movement tasks in the fourth state as a result of determining, based on comparison of the third value to the fourth value, that utilization of the multiple moving machines is greater when the multiple queues of item-movement tasks have the fourth state. Thus, selecting the alternative destination location resulted in reducing the empty travel time of the operator and/or the aggregate empty travel time for the warehouse. Because the operator and/or the warehouse are more efficient, the swap in blocks 428-438 can be kept.

If the modified global efficiency metric is not improved, then the computer system can revert to task assignments before the modification in 442. For example, the computer system can determine, based on comparison of the third value to the fourth value, that utilization of the multiple moving machines is greater when the multiple queues of item-movement tasks have the third state. Accordingly, the computer system can modify the third item-movement task to have the original destination location, to revert the multiple queues of item-movement tasks to the third state.

As mentioned above, in some implementations, the computer system can modify a source pallet for a task instead of or in addition to modifying the destination location for the task (444). Similar to modifying the destination location of the task, the computer system can randomly select a task to modify a source pallet in 446.

The computer system can then identify a set of alternative source pallets for the selected task in 448. The alternative source pallets can be identified based on whether they have a same type of items as the items in the selected task. The alternative source pallets can also be identified based on whether they have same storage conditions, customer number/identifier, SKU, quantity, as the selected task. In some implementations, the alternative source pallets can also be identified based on whether they are accessible, currently available (e.g., not currently used to complete a task), and/or the operator has the necessary equipment to access the alternative source pallets.

Once the alternative source pallets are identified, the computer system can randomly select an alternative source pallet in 450. The computer system can modify the third item-movement task from the first queue of item-movement tasks while the multiple queues of item-movement tasks have the third state (i) from selecting an original item from an original source location (ii) to selecting an alternative item from an alternative location to form the fourth state of the multiple queues of item-movement tasks, the alternative item being a same type of item as the original item. As described in reference to selecting the alternative destination location, the computer system can select any of the alternative source pallets, a highest-ranked alternative source pallet, and/or an alternative source pallet that is closest to a current location of the operator.

The computer system can then determine a modified global efficiency metric based on the randomly selected source pallet in 452. In other words, the computer system can determine how much empty time the operator can spend between tasks when the selected task involves the randomly selected source pallet. The computer system can determine the third value that indicates utilization of the multiple moving machines based on the multiple moving machines performing the multiple queues of item-movement tasks while the multiple queues of item-movement tasks have the third state. The third state can be a state of the warehouse before the alternative source pallet was randomly selected. The computer system can also determine the fourth value that indicates utilization of the multiple moving machines based on the multiple moving machines performing the multiple queues of item-movement tasks while the multiple queues of item-movement tasks have the fourth state. The fourth state is when the alternative source pallet has been randomly selected.

The computer system can then determine whether the modified global efficiency metric improved from the global efficiency metric before the modification in 454. In other words, the computer system can determine whether the operator experiences less empty time between tasks when the operator completes the selected task with the randomly selected alternative source pallet than when the operator completes the selected task with the original source pallet.

If the modified global efficiency metric is improved, the computer system can keep the modified task with the selected alternative source pallet in 456. The computer system can determine, based on comparison of the third value to the fourth value, that utilization of the multiple moving machines is less when the multiple queues of item-movement tasks have the third state. Thus, the computer system can leave the third item-movement task in the fourth state. The fourth state, as described above, indicates that the source pallet was swapped with another source pallet.

If the modified global efficiency metric is not improved, then the computer system can revert to the task assignment before the modification was made in 458. The computer system can determine, based on comparison of the third value to the fourth value, that utilization of the multiple moving machines is greater when the multiple queues of item-movement tasks have the third state. Thus, the computer system can modify the third item-movement task to select the original item from the original source location, to revert the multiple queues of item-movement tasks to the third state.

As an example, the randomly selected alternative source pallet can be located behind pallets in a storage rack. The original source pallet can be located in front of other pallets in a storage rack. By completing the same task but retrieving the alternative source pallet, the operator may be required to spend time removing the pallets in front of the alternative source pallet, pulling out the alternative source pallet, and then returning the other pallets to the storage rack. On the other hand, by completing the same task but retrieving the original source pallet, the operator may only be required to pick up the original source pallet without moving any other pallets. As a result, the operator can spend less time picking up the original source pallet, thereby spending less overall time to complete the task. The computer system can therefore determine that the operator is more efficient if the operator completes the task with the original source pallet. Thus, the computer system can revert to the task assignment involving the original source pallet rather than the randomly selected alternative source pallet.

As yet another example, the randomly selected alternative source pallet can be located behind pallets in a storage rack. The original source pallet can be located in front of other pallets in a storage rack. However, the randomly selected alternative source pallet can be in a location that is closer to the current location of the operator and the original source pallet can be located farther away from the current location of the operator. Thus, by completing the task with the randomly selected alternative source pallet, the operator can spend less time completing the task, even if the operator must pull the other pallets out before accessing the alternative source pallet. Since the overall completion time of the task with the randomly selected alternative source pallet can be less than the overall completion time of the task with the original source pallet, the computer system can keep the modification and assign the task to the operator with the randomly selected alternative pallet.

The computer system can continuously repeat blocks 414-458 in the process 400. For example, in some implementations, whenever the computer system determines that a modification or swap should not be kept (e.g., refer to blocks 426, 442, and 458), the computer system can try swapping or modifying different tasks for the same or different operators. Since the computer system can continuously repeat blocks 414-458, swaps and/or modifications can be made relative to dynamic changes to a state of the warehouse. The computer system can therefore make accurate and effective swap and/or modification determinations as well as global efficiency metric assessments based on the current state of the warehouse, which can be advantageous to improve overall warehouse efficiency.

Still referring to the process 400 in FIGS. 4A-E, the computer system can determine whether the operator requested a task in 460 (e.g., refer to FIG. 5). The operator can have a user device, such as a laptop, computer, mobile device, smartphone, or other computing device. The operator can provide input to the user device indicating that the operator has completed a task and is ready to execute another, new task.

If the operator requested a task, then the computer system can send the operator a highest task in the operator's queue in 462. The highest task in the operator's queue can be an initially assigned task, a swapped task, and/or a task having a modified destination location and/or source location, based on the computer system performing the blocks 402-458 up to the point that the request for the task is received in 460.

Once the highest task is sent to the operator, the computer system can mark the task as in progress in 464. A task that is marked as in progress is one that may not be used in subsequent swap determinations. After all, the computer system cannot swap a task that is currently being performed with another task because doing so can cause inefficiencies and delays in the warehouse. Instead, the computer system can proceed with making swap determinations and/or task modifications that involve a second highest ranked task in the operator's queue (which may now become the highest ranked task in the operator's queue once the highest task that was sent to the operator was marked as in progress).

After marking the highest task as in progress, the computer system can determine whether another truck has arrived at the warehouse in 466. Moreover, if the operator did not request a task, then the computer system can determine whether another truck has arrived at the warehouse in 466. The computer system can be in communication with a warehouse management system (WMS) that can receive updates about inbound and outbound trucks at the warehouse. Thus, the WMS can receive notification of the arrival of the truck. The WMS can then transmit the notification to the computer system.

If another truck arrived at the warehouse, then a current state of the warehouse has changed. Since the current state of the warehouse has changed, one or more additional tasks may need to be executed that involve the truck that just arrived. In some implementations, the one or more additional tasks can be higher priority than one or more tasks that have initially been assigned to the operators' queues. For example, the truck can include pallets that require immediate cold storage while the initially assigned tasks may not have any storage limitations or conditions.

As a result, when the truck has arrived, the computer system can return to block 402 and perform blocks 402-464. The computer system may generate new or updated tasks queues for each of the operators and perform swap and/or modification determinations for one or more of the operators' queues of tasks. The computer system can perform the blocks 402-464 in order to determine optimal task selection for each of the operators that can result in an improved global efficiency metric.

If another truck has not yet arrived, the computer system can return to block 414. Since there has not been a change of state of the warehouse, the computer system may not need to generate new or updated queues of tasks for each of the operators. Instead, the computer system can continue with performing swap and/or modification determinations using the current queues of tasks, as represented by blocks 414-464.

Referring to the process 400 in FIGS. 4A-E, the computer system can retrieve additional information from one or more data stores that can be used to assess task swaps and/or modifications. For example, the computer system can retrieve the queue of tasks assigned to each operator using an operator identifier. The queue can include, for each task, a task reference or identifier, a task type (e.g., put-away, staging, replenishment, etc.), a task creation time, a task status (e.g., in progress, not yet assigned, etc.), a task target completion time, a location name of a pallet associated with the task (e.g., or a set of locations for feasible substitution pallets for outbound tasks), location coordinates for the pallet associated with the task, a set of mechanical equipment that can be used to execute the task, a set of IT equipment that can be used to execute the task, a flag indication of whether the pallet is on a top or bottom of a double stack, whether the pallet is a double pallet, a location name for the pallet destination (e.g., or a set of locations; can include put-away, stage, dock door, dock lane, drop, replenishment, reverse replenishment, full pallet, moves, relocation, etc.), location coordinates for the pallet destination (e.g., which can be calculated based on the location name), and/or a confirmation number for an inbound or outbound truck that corresponds to the task.

In some implementations, the computer system may also retrieve and use information about items on the pallet, such as owner identifier, item identifier, item description, item identifier data, item group, case quantity on the pallet, height, dimensions, case height, gross case weight, temperature zone, pallet platform type, and velocity. The computer system may also retrieve information about one or more trucks with known appointment times referenced in the queue of tasks. The truck information can be dynamically updated whenever a new appointment is made or a new truck arrives at the warehouse. The truck information can include truck confirmation number, appointment time, arrival time of the truck that generated the task (e.g., which can be blank if the truck has not yet arrived), target time of the truck that generated the task (e.g., which can be a time at which the truck must be finished unloading/loading, such as 2 hours after truck arrival), a door to which the truck is assigned (e.g., which can be updated to an actual location of the truck once the truck arrives at the warehouse), a set of dock lanes used for this truck (e.g., which can be empty until a door number and lane number of the truck is known), a number of pallets complete (e.g., for inbound cases, the pallets are already unloaded from the truck, and for outbound cases, the pallets are already loaded into the truck), and an estimate of a total number of pallets in the truck.

The computer system can also access inventory information for all locations in the warehouse, which can be used to determine optimal task swaps and/or modifications. The inventory information can be updated whenever there is a change at any location name in the warehouse (e.g., a pallet is stored at a particular location, a pallet is pulled from a particular location, a truck arrives at a dock door, etc.). The inventory information can include location name, coordinates, temperature zone, velocity percentile, maximum height, maximum weight, capacity (e.g., maximum number of pallets), type (e.g., storage last-in-first-out, storage first-in-first-out, pick zone, staging, mole rack, etc.), and a set of pallets currently in the location. The set of pallets can include additional information such as depth in the location, owner code, item identifier (e.g., code, barcode, label, SKU, QR code), and identifier data.

In some implementations, the computer system can retrieve information about each of the operators that are currently signed in to execute tasks. The operator information can be updated whenever an operator signs in or out. The operator information can also be updated whenever a task assignment is swapped or otherwise modified. The operator information can include an operator identifier, the operator's current group assignment (e.g., dock, full movement, case pick, etc.), task types that the operator is trained to perform, mechanical equipment that the operator is using, IT equipment that the operator is using, a last known location name of the operator (e.g., current location), last known coordinates of the operator, and a task reference number that the operator is currently executing or has completed executing.

Moreover to project empty travel time per operator, the computer system can retrieve warehouse configuration information. The configuration information can include a directed graph network that describes a map of the warehouse. Nodes of the directed graph network can represent input and output locations and grid locations throughout the warehouse. The nodes can also have centered coordinates. Directed edges between the nodes can be used to represent feasible paths between the nodes. The paths may be used by the operator in completing any of the tasks in the operator's queue. The computer system can use one or more additional or fewer pieces of information in order to determine optimal task swaps and/or modifications that improve or otherwise maintain the global efficiency metric for the warehouse.

In some implementations, the computer system can perform the swapping of tasks (block 414), the modifying of a task to use a different destination location (block 426), and the modifying of a task to use a different source pallet (block 444) in a different order. For example, the computer system may change the queues of one or more operators by randomly performing any of the blocks 414, 426, and 444, such that multiple swaps (block 414) may be performed, then a source pallet can be changed (block 444), and then two destination locations can be changed (block 426). In some implementations, a single change can include both swapping tasks (block 414) and/or changing destination locations (block 426) and/or changing source pallets (block 444), such that a task may be both swapped and its origin and/or destination swapped.

FIG. 5 is a flowchart of a process 500 for assigning a warehouse operator a next task to complete. The process 500 can be performed when the operator requests a task in block 460 in the process 400 depicted in FIGS. 4A-E. The process 500 can be performed by a user computing device of the operator, such as a mobile phone, laptop, tablet, or computer. The process 500 can also be performed by another computing device, computer system, network of computing devices, and/or servers. For example, one or more blocks of the process 500 can be performed by the computer system 114. In some implementations, one or more blocks of the process 500 can be performed by a warehouse management system (WMS). For illustrative purposes, the process 500 is described from a perspective of an operator user device.

Referring to the process 500, the operator user device can request a new task in 502. As described herein, a new task can be requested once the operator completes a current task. In some implementations, a new task can be requested once the operator is about to complete the current task. As a result, any time lag between transmitting the request and receiving the new task can be filled with the operator completing the current task. This means that the operator may not experience downtime between tasks, which can be advantageous to improve overall efficiency of the operator.

In some implementations, the operator can provide input to the operator user device that indicates the new task is being requested. In some implementations, the operator user device can automatically request the new task without human intervention. For example, the operator user device can track movement of the operator in the warehouse. Once the operator user device determines that the operator is at a destination location of the current task, the operator user device can determine that the operator has completed or is about to complete the current task. Accordingly, the operator user device can automatically request the new task. Automatic requests for new tasks can also be advantageous to reduce an amount of empty time that the operator can spend manually requesting the new tasks. As a result, overall efficiency of the operator can be improved.

As part of requesting the new task, the operator user device can transmit location information of the operator in 504. The operator user device can also transmit information about a last task that was completed in 506. The request for the new task can include additional input data that can be used by the computer system 114 to determine what new task to assign to the operator. For example, the request can include a facility code identifying what warehouse the operator is working in. The request can also include an identifier code for the operator, which can be used by the computer system 114 to identify the operator's queue of tasks and determine which task to assign next.

The operator user device can determine the current location of the operator using triangulation techniques and/or one or more location presence signals that are received from location sensing devices placed throughout the warehouse. In some implementations, the operator can manually input their current location to the operator user device. In yet some implementations, when the operator user device cannot determine, in real-time, the current location of the operator, the operator user device can retrieve the destination location of the last task (e.g., from a data store) and identify that location as the operator's current location.

The information about the last task completed can include how long it took the operator to complete, how much empty time the operator experienced between the last task and a task prior to the last task. The information can also include the destination location of the last task. One or more additional or fewer information about the last task can be transmitted in 506.

As described herein, the request along with the location and last task information can be transmitted to the computer system 114. The computer system 114 can use this information to determine what new task to assign to the operator that will improve or otherwise maintain an efficiency metric of the operator as well as the global efficiency metric of the warehouse (e.g., refer to FIGS. 1-4).

Once the computer system 114 determines what new task can be assigned to the operator, the operator user device can receive the new task to perform in 508. In other words, the computer system 114 can send first instructions to cause a first moving machine (e.g., the operator) to perform a next-to-perform task from a first queue of item-movement tasks. The first queue can be assigned to the first moving machine, where each moving machine can be assigned their own queue. The next-to-perform task can be a highest-ranked task in the first queue. For example, the next-to-perform task can be an initially assigned task for the operator, a swapped task, a task with a modified destination, or a task with a modified source pallet.

The operator user device can display new task information in 510. For example, the operator user device can include a display screen having a graphical user interface (GUI) display. The operator can provide input using the GUI display. The operator can also view output via the GUI display. The new task information can include a warehouse identifier, the operator's identifier, a set of task reference or identifier numbers (e.g., which can contain multiple values where the task involves a double stacked pallet), a set of locations for the pallet (e.g., which can contain multiple values where the task involves a double stacked pallet), and a target location to which the pallet needs to be transported. The new task information can further include instructions that direct the operator from the operator's current location to a destination location or end location of the task. The instructions can include directions that guide the operator through the warehouse. The instructions can also be step-by-step instructions about what pallet the operator must pick up and/or how the operator can arrange the pallet in its destination location. The new task information can also include an amount of time that the operator is expected to take to complete the task, a penalty if the operator exceeds the expected time, and an expected amount of empty time that the operator will experience between tasks.

Using the displayed information, the operator can proceed to perform the new task. In some implementations, the operator user device can transmit a notification to the computer system 114 indicating that the operator is currently performing the new task. Thus, as described in reference to the process 400 in FIGS. 4A-E, the computer system 114 can mark the new task as in progress (e.g., refer to block 464 in FIG. 4E).

The operator user device can receive input indicating that the new task has been completed in 512. For example, once the operator puts a pallet associated with the new task into its designated storage location, the operator can be done with the new task. The operator can provide input to the operator user device that indicates the new task is done.

Accordingly, the operator user device can transmit a notification to the computer system 114 that the new task has been completed in 514. Once the computer system 114 receives this notification, the computer system 114 can perform the process 400 in FIGS. 4A-E by generating updated queues of tasks and assessing new swaps and/or modifications of tasks across queues and/or within the same queue.

Moreover, the process 500 can be repeated every time that the operator completes a current or new task and/or requests a new task. Thus, after the operator user device transmits the notification that the new task has been completed in 514, the operator user device can return to block 502 and repeat blocks 502-514. The blocks 502-514 can be repeated for as long as the operator associated with the operator user device is signed in to be working in the warehouse. Additionally, the process 500 can be performed by each operator user device of each operator that is signed in to be working in the warehouse. In some implementations, a centralized computer system, such as a WMS, can perform the process 500 for each of the operators that are signed in to be working in the warehouse.

The techniques described throughout this disclosure can be used in a variety of settings or applications in a warehouse environment or similar storage facility. As mentioned, assessment of task swaps and/or modifications can be performed for tasks that involve moving items from a truck to a dock area and vice versa, full pallet moves throughout the warehouse, case picking, assembly of mixed pallets and storage of such pallets, automatic conveyor lanes, and automatic dock lanes.

For example, tasks in dock queues can include unloading, receiving, and loading. Unloading can include moving a pallet from a truck to a dock lane. Receiving can include capturing data on the pallet in the dock lane. Loading can include moving the pallet from a dock lane into a truck. The techniques described herein can be executed once an operator is available to execute a new task in the dock area. The operator can become available when the operator finished a task in the dock area, switched task groups to dock tasks, or otherwise can perform dock tasks in addition to or in lieu of other tasks in the warehouse. Once a request for a new dock task is received by a computer system (e.g., the computer system 114), the computer system can retrieve information about queues of dock tasks that can be used to determine what new task to assign to the operator. The received information can include information previously described throughout this disclosure as well as task type (e.g., loading, receiving, unloading, etc.), current location name of a pallet associated with the task (e.g., dock door, dock lane, etc.), and a target location name of the pallet (e.g., dock door, dock lane, a location inside a freezer, truck, etc.). The computer system can also retrieve information about trucks that are references in the queues. The truck information can include information previously described throughout this disclosure as well as a door to which the truck is assigned and a set of dock lanes used for the truck. Moreover, the computer system can retrieve location information about all locations in the dock area, including dock lanes and dock doors. The location information can include location name, coordinates, and set of pallets in that location. As described above, the computer system can also retrieve information about all operators that are currently signed in to execute tasks in the warehouse, regardless of whether they are assigned dock tasks or other tasks. In addition to the operator information described above, the computer system can also retrieve information about a task that the operator is currently performing, which can include a source location name (e.g., location at which the pallet was at a beginning of executing the task), source location coordinates, target location name (e.g., an end destination location to which the pallet is transported), and target location coordinates. Finally, the computer system can generate output after assessing task swaps and/or modifications that includes a target location name for a next dock task to execute. The target location can be a dock door, dock lane, truck, or other location in the dock area. The output can also provide instructions on how to complete the next dock task.

As another example, the disclosed techniques can be used for selecting tasks in the dock area of an automated warehouse. The disclosed techniques can be used in hybrid warehouses that are between fully automated warehouses with conveyor lanes and manual warehouses with dock lanes. The automated dock tasks can include inbound to an infeed conveyor belt, inbound to a dock lane, reworking at a platform, reworking from a platform for a fix pallet, receiving on a dock lane, moving a pallet to a slat area, moving a pallet into a freezer unit, moving a pallet out of a freezer unit, de-slatting a pallet, re-ingesting a pallet, outbound staging, and outbound loading. The computer system can retrieve information about queues of automated dock tasks. In addition to the information previously described, the information for each of the automated dock tasks can further include a current location name of a pallet for each task (e.g., door, conveyor, dock lane, freezer unit, truck, etc.), a set of mechanical equipment that can be used to execute the task, a set of IT equipment that can be used to execute the task, and a set of target locations to which a pallet needs to be automatically moved to. The computer system can also retrieve information about all locations in the dock area, which can include all dock doors (e.g., trucks), dock lanes, conveyor positions on an inbound section of the conveyor belts (e.g., before T-car, conveyor loop, RGV loop, etc.), conveyor positions on an inbound section of the conveyor belts (e.g., after T-car, conveyor loop, RGV loop, etc.), floor locations identified for slatting, and locations in freezer units. Each of these locations can include additional data, such as location type, capacity (e.g., maximum number of pallets), set of pallets currently in the location, and data associated with each of the set of pallets. The data associated with each pallet can include a location, associated truck or order number, classification of an outbound pallet, and depth in the location (e.g., for multi-deep locations). Moreover, the computer system can retrieve configuration information associated with the warehouse, which can include all locations in the warehouse. This can include all conveyor locations and edges between neighboring automation locations. Length and capacity data associated with each edge can also be included in the configuration information. The location and capacity data can be used, for example, by the computer system to determine empty travel time between tasks and projected task completion times.

Similarly, the disclosed techniques can be used for selecting tasks in automated warehouses with conveyor lanes. Automated conveyor tasks can pertain to staging pallets on outbound conveyor belts or lanes. The automated conveyor tasks can include inbound to infeed conveyor belts, outbound loading of pallets from conveyor lanes into trucks, reworking pallets at a platform, reworking from platforms to fix pallets, inbound to dock lanes, inbound to freezer units, receiving pallets on a dock lane, receiving pallets from a freezer unit, moving pallets to a slat area, moving pallets into a freezer unit or tempering, moving pallets out of a freezer unit or tempering, deslatting, and re-ingesting pallets. The computer system can retrieve same or similar information as described above in order to assess automated conveyor task swaps and/or modifications.

As yet another example, tasks in case picking can include picking items that can be used to build mixed pallets and storing the mixed pallets. Thus, a case picking task may not be completed until the operator puts away the built mixed pallet in a storage location. The storage location, in some implementations, can be close to dock lanes and can be easily accessible for staging the pallet in the dock area when an outbound truck arrives. Assessment of case picking task swaps and/or modifications can be performed by the computer system once the operator finishes building a case pick pallet (e.g., including storing the case pick pallet), the operator switches task groups to building case pick pallets, or the operator is otherwise able to perform case picking tasks. The computer system can retrieve information about the queues of case picking tasks. In addition to the tasks information described above, the case picking tasks information can also include a truck or order number associated with the particular case picking and data on a set of build steps for each case picking task. Each build step can include data such as a location from which the operator needs to pick items, a location name of the pallet that the operator will pick from, a build order for the pallet, and a number of cases to pick.

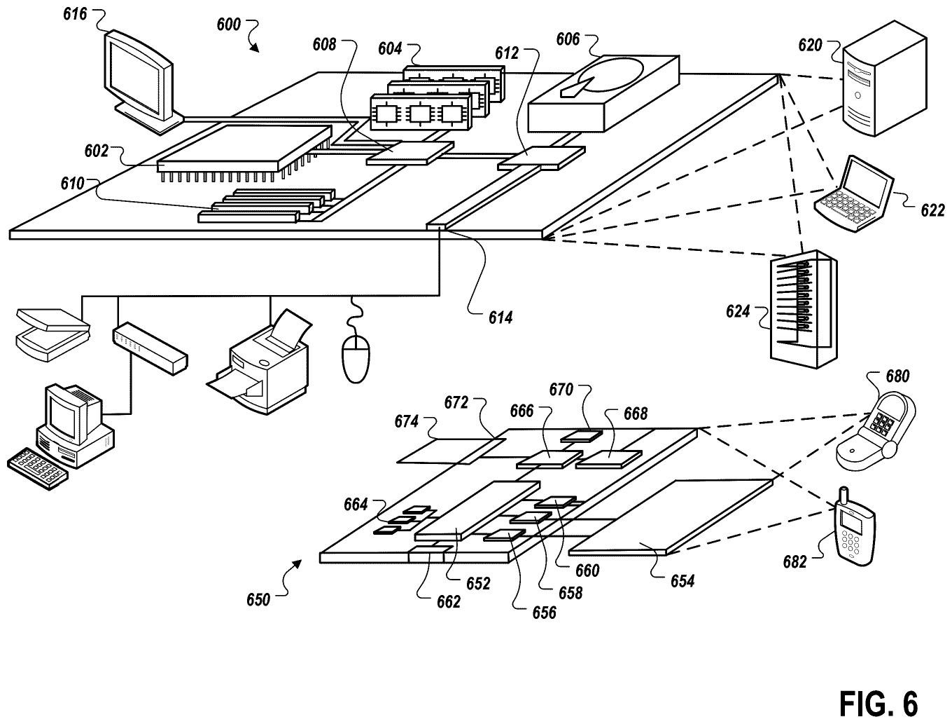

FIG. 6 is a schematic diagram that shows an example of a computing device 600 and a mobile computing device that can be used to perform the techniques described herein. The computing device 600 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 600 includes a processor 602, a memory 604, a storage device 606, a high-speed interface 608 connecting to the memory 604 and multiple high-speed expansion ports 610, and a low-speed interface 612 connecting to a low-speed expansion port 614 and the storage device 606. Each of the processor 602, the memory 604, the storage device 606, the high-speed interface 608, the high-speed expansion ports 610, and the low-speed interface 612, are interconnected using various busses, and can be mounted on a common motherboard or in other manners as appropriate. The processor 602 can process instructions for execution within the computing device 600, including instructions stored in the memory 604 or on the storage device 606 to display graphical information for a GUI on an external input/output device, such as a display 616 coupled to the high-speed interface 608. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 604 stores information within the computing device 600. In some implementations, the memory 604 is a volatile memory unit or units. In some implementations, the memory 604 is a non-volatile memory unit or units. The memory 604 can also be another form of computer-readable medium, such as a magnetic or optical disk.

The storage device 606 is capable of providing mass storage for the computing device 600. In some implementations, the storage device 606 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 604, the storage device 606, or memory on the processor 602.

The high-speed interface 608 manages bandwidth-intensive operations for the computing device 600, while the low-speed interface 612 manages lower bandwidth-intensive operations. Such allocation of functions is exemplary only. In some implementations, the high-speed interface 608 is coupled to the memory 604, the display 616 (e.g., through a graphics processor or accelerator), and to the high-speed expansion ports 610, which can accept various expansion cards (not shown). In the implementation, the low-speed interface 612 is coupled to the storage device 606 and the low-speed expansion port 614. The low-speed expansion port 614, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 600 can be implemented in a number of different forms, as shown in the figure. For example, it can be implemented as a standard server 620, or multiple times in a group of such servers. In addition, it can be implemented in a personal computer such as a laptop computer 622. It can also be implemented as part of a rack server system 624. Alternatively, components from the computing device 600 can be combined with other components in a mobile device (not shown), such as a mobile computing device 650. Each of such devices can contain one or more of the computing device 600 and the mobile computing device 650, and an entire system can be made up of multiple computing devices communicating with each other.

The mobile computing device 650 includes a processor 652, a memory 664, an input/output device such as a display 654, a communication interface 666, and a transceiver 668, among other components. The mobile computing device 650 can also be provided with a storage device, such as a micro-drive or other device, to provide additional storage. Each of the processor 652, the memory 664, the display 654, the communication interface 666, and the transceiver 668, are interconnected using various buses, and several of the components can be mounted on a common motherboard or in other manners as appropriate.

The processor 652 can execute instructions within the mobile computing device 650, including instructions stored in the memory 664. The processor 652 can be implemented as a chipset of chips that include separate and multiple analog and digital processors. The processor 652 can provide, for example, for coordination of the other components of the mobile computing device 650, such as control of user interfaces, applications run by the mobile computing device 650, and wireless communication by the mobile computing device 650.

The processor 652 can communicate with a user through a control interface 658 and a display interface 656 coupled to the display 654. The display 654 can be, for example, a TFT (Thin-Film-Transistor Liquid Crystal Display) display or an OLED (Organic Light Emitting Diode) display, or other appropriate display technology. The display interface 656 can comprise appropriate circuitry for driving the display 654 to present graphical and other information to a user. The control interface 658 can receive commands from a user and convert them for submission to the processor 652. In addition, an external interface 662 can provide communication with the processor 652, so as to enable near area communication of the mobile computing device 650 with other devices. The external interface 662 can provide, for example, for wired communication in some implementations, or for wireless communication in other implementations, and multiple interfaces can also be used.

The memory 664 stores information within the mobile computing device 650. The memory 664 can be implemented as one or more of a computer-readable medium or media, a volatile memory unit or units, or a non-volatile memory unit or units. An expansion memory 674 can also be provided and connected to the mobile computing device 650 through an expansion interface 672, which can include, for example, a SIMM (Single In Line Memory Module) card interface. The expansion memory 674 can provide extra storage space for the mobile computing device 650, or can also store applications or other information for the mobile computing device 650. Specifically, the expansion memory 674 can include instructions to carry out or supplement the processes described above, and can include secure information also. Thus, for example, the expansion memory 674 can be provide as a security module for the mobile computing device 650, and can be programmed with instructions that permit secure use of the mobile computing device 650. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 664, the expansion memory 674, or memory on the processor 652. In some implementations, the computer program product can be received in a propagated signal, for example, over the transceiver 668 or the external interface 662.

The mobile computing device 650 can communicate wirelessly through the communication interface 666, which can include digital signal processing circuitry where necessary. The communication interface 666 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 668 using a radio-frequency. In addition, short-range communication can occur, such as using a Bluetooth, WiFi, or other such transceiver (not shown). In addition, a GPS (Global Positioning System) receiver module 670 can provide additional navigation- and location-related wireless data to the mobile computing device 650, which can be used as appropriate by applications running on the mobile computing device 650.

The mobile computing device 650 can also communicate audibly using an audio codec 660, which can receive spoken information from a user and convert it to usable digital information. The audio codec 660 can likewise generate audible sound for a user, such as through a speaker, e.g., in a handset of the mobile computing device 650. Such sound can include sound from voice telephone calls, can include recorded sound (e.g., voice messages, music files, etc.) and can also include sound generated by applications operating on the mobile computing device 650.

The mobile computing device 650 can be implemented in a number of different forms, as shown in the figure. For example, it can be implemented as a cellular telephone 680. It can also be implemented as part of a smart-phone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

FIG. 7 is a flowchart of a process 700 for prioritization of tasks in an environment, such as a facility or warehouse environment. The process 700 can be performed, for example, to prioritize truck loading and other dock-area operations, even in scenarios where workers do not have system-based task assignments. As a result, dock workers or other relevant users in the facility can be continuously assigned prioritized tasks even when they do not have system-based task assignments. The process 700 can ensure that outbound and/or inbound tasks may be prioritized such that workers assigned different tasks/functions can be continuously provided with tasks. The process 700 addresses shortcomings with trucks needing to be loaded in a particular order, where traditionally, if pull pallets needed to be loaded at a later time, a worker loading other pallets would be stopped from performing their tasks until those pull pallets are loaded. With the process 700, that worker can be assigned other tasks that are prioritized in the facility while they wait to complete the task of loading the pull pallets. In turn, the process 700 can improve overall operational efficiencies in the facility, prevent workflow interruptions that may be caused by loading pallets out of order, and balance productivity across different job functions and technologies in the facility. The process 700 further can reduce overall computational resource usage (e.g., CPU cycles, network bandwidth) by at least threshold amounts or levels to improve operations of computer systems described herein and real-time accuracy of these operations. The process 700 can be combined with one or more other processes described herein, such as the process 400 in FIGS. 4A, 4B, 4C, 4D, and 4E, and process 800, 900, and 1000 in FIGS. 8, 9, and 10A and 10B, respectively.

Operations in the process 700 can be performed by components of the computer system 114 described herein. In some implementations, one or more of the operations can be performed by other computer systems, computing devices, network devices, and/or edge devices. For illustrative purposes, the process 700 is described from the perspective of a computer system.

Referring to the process 700 in FIG. 7, the computer system can receive information about workers in a facility (block 702). The information can include a current location of each worker, a past location of each worker, a task or set of tasks assigned to each worker, a task or set of tasks that were completed by each worker, a location of a current task, a last task, and/or an upcoming task of each worker, and/or any combination thereof. The information can be received from a computing device of each worker. Sometimes, the information can be received from a computer system associated with the facility, such as a WMS. In yet some implementations, the information can be received from sensors and/or other devices that are positioned throughout the facility.

The computer system can determine whether a worker is performing a system-assigned task in block 704. A system-assigned task can be determined automatically, by the computer system, using one or more of the techniques described in reference to at least FIGS. 1B, 4A, 4B, 4C, 4D, and 4E. If the worker is performing a system-assigned task, the computer system can return to block 702, to continuously receive the information about the workers in the facility. If the worker is not performing a system-assigned task (which means the worker may be idle or performing other tasks in the facility that are not determined by the computer system using the disclosed techniques) in block 704, then the computer system can retrieve an active truck loading queue (e.g., from a WMS described herein) (block 706). The truck loading queue can indicate an order by which trucks that arrive or are at the facility should be loaded and/or unloaded. The truck loading queue can also indicate, for each of the trucks, an order by which pallets or other items should be loaded and/or unloaded on that particular truck.

The computer system can rank truck loading tasks in the queue based on a truck departure schedule, pallet sequence(s) for loading or unloading, and/or operational constraints (block 708). The truck loading tasks can be ranked from highest priority to lowest priority. The priority can be determined based on a combination of factors, as mentioned above. As an example, a first truck that is scheduled to depart earlier than second truck can be ranked higher than the second truck, especially if the first truck is falling behind regarding being on time. As another example, if the second truck is scheduled to depart later than the first truck but the second truck will receive more pallets that are closer in travel distance to the second truck than pallets for the first truck, the second truck may be ranked higher. As a result, the second truck can depart from the facility earlier, thereby opening a bay/dock door to receive an incoming truck. This can result in improved operational efficiencies of the facility as a whole.

Sometimes, the truck departure schedule can be predetermined or provided with information about the particular truck (e.g., from a customer, from the truck). Sometimes, the truck departure schedule can be predicted by the computer system, using one or more machine learning models and/or artificial intelligence (AI). The operational constraints can be associated with the facility and/or the particular truck. For example, operational constraints of the facility can include availability of workers in a dock area where the truck is being loaded and/or loaded. Operational constraints of the facility can sometimes include availability of autonomous vehicles in the facility to perform one or more tasks associated with the truck loading/unloading. Sometimes, operational constraints of the facility can include availability of energy or other resources for performing the tasks associated with the truck loading/unloading.

In block 710, the computer system can select a highest-priority task that satisfies one or more assignment criteria. For example, the computer system can select the task that corresponds to the worker's current location and/or zone (block 712). In other words, the computer system can select the task that is closest to the worker's current location/zone and/or within a threshold distance of the worker's current location/zone. As a result, the worker would not have to expend unnecessary resources to move to the location of the particular task. As another example, the computer system can select the task that does not disrupt a loading sequence for a respective truck (block 714). Sometimes, the assignment criteria can include both blocks 712 and 714.

Moreover, the computer system can apply balancing logic to system-tasked workers and non-system tasked workers to select the highest-priority task for the worker (block 716). The balancing logic can include capacity-based allocation such that the computer system maintains a target ratio of tasks between the system-tasked workers and the non-system tasked workers (e.g., 70:30). If the system-tasked workers are underutilized (e.g., below some predetermined threshold), then the computer system can determine to reduce assignments to non-system tasked workers. If the non-system tasked workers are idle, on the other hand, the computer system may allow them to take lower-priority tasks in the ranked tasks that may not disrupt a main sequence of tasks that are assigned and performed using the disclosed techniques.

Another example of the balancing logic in block 716 can include priority reservation, in which the computer system can reserve a threshold percentage of high-priority tasks for the system-tasked workers. When assigning the tasks to the non-system tasked workers, the computer system may therefore exclude tasks that may be marked as critical or sequence-sensitive, unless no system-tasked workers are available.

Another example of the balancing logic can include dynamic queue rebalancing. The computer system can continuously monitor task completion rates and/or adjust the task queue(s) and/or assignments dynamically. If the system-tasked workers are falling behind in task completion, the computer system may temporarily control or restrain assignments to the non-system tasked workers and reallocate the tasks back to queues for the system-tasked workers. Yet another example of the balancing logic can include zone-based segmentation. The computer system can assign the non-system tasked workers to less congested zones and/or less critical zones, especially if such zones are close to these workers and/or within a threshold distance of their current locations. This can result in preventing overlap in high priority areas and/or potentially congested areas where the system-tasked workers may need additional flexibility for optimization.

Another example of the balancing logic can include use of an idle-time penalty. The computer system can apply a penalty score where any worker is left idle for at least a threshold amount of time (e.g., 1 minute, 3 minutes, 5 minutes). Therefore, if a non-system tasked worker is idle for at least the threshold amount of time, the computer system can assign them a task, such as a high priority task, even if it slightly reduces global efficiency for the facility, and so long as that task assignment does not block critical paths or cause congestion in the zones of the facility.

The computer system can then generate and return instructions to a device of the worker to perform the selected task in block 718. The instructions can include graphics, audio, and/or text information that instructs the worker to perform the task. The instructions can sometimes include step-by-step instructions guiding the worker through the task. The instructions can be presented/outputted by the device of the worker, which can include a handheld device, headset, smart glasses, smartwatch, other wearable devices, and/or a display affixed to equipment thar is used by the worker (e.g., a forklift).

In block 720, the computer system can mark the selected task as in progress. As a result, the task may no longer be part of the queue for assigning to other workers. Sometimes, the process 700 may stop at block 720. Sometimes, the process 700 may return to block 702 and continuously receive information about the workers and assign tasks accordingly.

In some implementations, after block 720, the computer system can optionally recalculate priorities for remaining tasks in the queue to preferred loading sequences (block 722). Based on the selected task being assigned to the worker and performed by the user, an order by which other tasks in the queue are to be performed may change. The order by which the other tasks may be performed can also depend on the loading/unloading sequences(s) for the respective trucks, whether an associated truck is set of an on-time departure, whether the associated truck is no longer set for an on-time departure, whether one or more of the workers in the facility are falling behind in timeliness of their task completions, other changes in the operational constraints, the availability of other workers in the facility, the progress of task completion by the system-tasked workers, etc.

As described in reference to FIG. 1A, sometimes the computer system may only recalculate the priorities for tasks remaining in the queue that are impacted by the task assignment in blocks 710-720. As a result, the computer system can identify which of the remaining tasks are associated with the assigned task (e.g., within a threshold distance of each other, associated with a same truck) and then recompute those priorities. This operation is efficient from a compute and network standpoint, as described above, to provide fast, real-time, efficient, and accurate task prioritization and assignment in the environment.

Optionally, the computer system can return to block 708 and re-rank the truck loading tasks in the queue based on the recalculated priorities for the remaining tasks. The computer system can return to block 708 and iterate through the blocks 708-722 until all the tasks in the queue have been assigned and/or priorities have been recalculated for all the remaining tasks.

Optionally, the computer system can return information about tasks being performed and/or in the queue in response to recalculating the priorities in block 722 (block 724).

FIG. 8 is a flowchart of a process 800 for minimizing congestion in an environment, such as a facility or warehouse, based on penalty-scoring of task assignments. This technological improvement allows for tracking locations and task assignments of workers in the facility to estimate congestion in aisles, bays, dock areas, or other zones in the facility. Penalties can be applied to tasks that may cause overlap in congested areas, helping to spread workers out and improve safety to avoid overcrowding in specific locations or reduced operational efficiencies.

As an illustrative example, the process 800 can be performed to reduce congestion/traffic in aisles, bays, dock areas, or other zones of a facility based on tracking real-time worker locations and applying penalties to tasks that would increase congestion. For example, based on information about where workers are in the facility, which tasks are assigned, which tasks are not assigned, which tasks are in progress, which tasks are not yet in progress, a computer system can estimate or predict congestion throughout the facility. Based on this determined congestion, the computer system can add penalties to particular tasks and/or pathways for task completion. The penalties can help from a safety perspective to prevent or otherwise deter potential accidents, without sacrificing global efficiency of the facility. Sometimes, the congestion and/or the penalties can be determined based on where a worker started a task and/or where they are going (instead of predicting when they will arrive at a next location associated with the task). The penalties can be applied to tasks that may have overlap with start and/or finish locations of those tasks (e.g., upcoming tasks, existing tasks, current tasks). Sometimes, the penalties can be applied to those tasks that have overlap with locations between the start and/or finish locations. As a result of the penalties, assignment of those tasks can be avoided to prevent the potential overlap and congestion that comes with the overlap. As a merely illustrative example, two workers cannot put/pull items/pallets from a same bay. As another example, multiple vehicles (e.g., autonomous vehicles, forklifts) cannot be moving in a same aisle without creating traffic, potential delays, and/or potential accidents. Therefore, penalties applied to tasks associated with these scenarios may reflect the potential congestion and thus deter the assignment of such overlapping tasks at a same or similar time. The process 800 further can reduce overall computational resource usage (e.g., CPU cycles, network bandwidth) by at least threshold amounts or levels to improve operations of computer systems described herein and real-time accuracy of these operations.

The process 800 can be combined with one or more other processes described herein, such as the process 400 in FIGS. 4A, 4B, 4C, 4D, and 4E, and process 700, 900, and 1000 in FIGS. 7, 9, and 10A and 10B, respectively. Operations in the process 800 can be performed by components of the computer system 114 described herein. In some implementations, one or more of the operations can be performed by other computer systems, computing devices, network devices, and/or edge devices. For illustrative purposes, the process 800 is described from the perspective of a computer system.

Referring to the process 800 in FIG. 8, the computer system can receive real-time location and task data for a facility in block 802. The received data can include current locations of workers (block 804). The received data can include start and finish locations of tasks, status of task completion, tasks assigned to each worker and/or a subset of workers in the facility, etc.

In block 806, the computer system can retrieve active task assignments and their associated location information. Sometimes, this information may be received as part of the task data in block 802. This information can be received from a WMS of the facility and/or a data storage system associated with the facility. The associated location information of the active task assignments can include a start location and/or a finish location associated with each active task assignment. As another example, the associated location information can include a current location of a worker performing each active task assignment. As yet another example, the associated location information can include a pathway that is expected to be followed by the worker performing the active task assignment.

The computer system can generate congestion scores for each zone (e.g., dock area, aisles, bays, storage rooms, racks) in a plurality of zones in the facility, which can be based on a number of workers present, a size of the zone, and/or historical movement patterns for the zone (block 808). The congestion scores can be determined using one or more algorithms, machine learning models, and/or artificial intelligence (AI). For example, the congestion scores can be determined based on predicting congestion in each of the zones in the facility based on the received real-time location and task data and the active task assignments and their associated location information. The congestion can be predicted or estimated based on the start and finish locations of task assignments. Sometimes, the congestion can be predicted or estimated based on predicted pathways of the task assignments. In yet some implementations, the congestion can be predicted or estimated only for zones in the facility where task assignments have same start and/or finish locations. The congestion scores can be numeric values indicating a level or amount of predicted/estimated congestion. A higher score, for example, can indicate a higher level or probability of congestion than a lower score. Sometimes, the congestion scores can be Boolean and/or string values. For example, the congestion score can have a value of True if there is predicted congestion for a particular zone and a value of False if there is no predicted congestion for a particular zone based on the current or active task assignments. One or more other values can also be used for the congestion scores.

Accordingly, the computer system can identify and tag one or more zones in the plurality of zones as high congestion zones, which can be based on determining that the one or more zones have corresponding congestion scores that exceed a threshold value (block 810). For example, if a zone is assigned a congestion score greater than the predetermined threshold value, the zone can be identified as high congestion zone. In this example, only zones where the probability of congestion is high or the congestion is likely to cause disruptions to worker efficiency, operational schedules, and/or global efficiency for the facility would be identified as high congestion zones. This can result in some zones having low probability of congestion or less congestion still being acceptable in the facility, especially if the lower congestion does not result in delays. In some implementations, any zone that is assigned a congestion score (e.g., a score value of True, a score value of 1 or greater than 1) can be identified as high congestion. As a result, any zone where workers and/or vehicles are expected to cross or share paths can be identified as high congestion. This can be beneficial to ensure that no two workers or vehicles have even a possibility of crossing paths when completing their respective task assignments.

For each candidate task in the task data, the computer system can apply a penalty score if a location of the candidate task is within a threshold distance of the high congestion zones in block 812. Sometimes, tasks that are located in the high congested zones may be assigned the penalty score while tasks that are not located in the high congested zones may not be assigned any penalty score. The penalty score can sometimes be a weight applied to a value indicating priority for that task to be completed. As another example, the penalty score can be applied as a weight to a ranking of the task in a list of tasks currently being performed, active, and/or to be performed.

In block 814, the computer system can optionally calculate a global efficiency metric for the facility and based on the applied penalty score(s). Sometimes, the global efficiency metric can be a combination or summation of values associated with the tasks in the list/task data.

The computer system can re-rank candidate tasks from the task data in a task queue based on the penalty score(s) (block 816). For example, the computer system can deprioritize each candidate task having the penalty score unless the candidate task is identified as critical (block 818). The computer system can also deprioritize candidate tasks having the penalty scores based on values of those scores (e.g., a greater value for the penalty score results in the associated task being ranked lower than another task having a lesser value for the penalty score). Sometimes, the computer system can prioritize the candidate tasks that do not have the penalty score(s) (block 820). Then, the candidate tasks having the penalty scores can be ranked based on those penalty scores (e.g., from lowest to highest score, where the highest score indicates a worst penalty or greatest congestion).

The computer system can assign the re-ranked tasks to the workers to ensure the assigning minimizes overlap in the high congestion zones in block 822. Any of the assignment techniques described herein may be used. Assigning the tasks can include assigning highest ranked tasks at a same or similar time, there those tasks do not have any penalty scores and thus no predicted overlap in the high congestion zones. Sometimes, the tasks can be assigned to workers at a same or similar time that do not intersect with any congested zones and thus have no penalty scores. In some implementations, the computer system can assign a task that does not intersect with any congestion zones at the same time as assigning a task that would intersect a congestion zone if that other task was assigned at the same time with another intersecting task.

Then, in block 824, the computer system can determine whether a change in facility conditions and/or operations has occurred/been detected. Such changes can include arrival of trucks to the facility, changes in movement or location of the workers in the facility, task completion status, and/or other changes in task assignment/completion. If a change in facility conditions/operations is detected, the computer system can return to block 808 and iterate through blocks 808-824 until no further condition/operational changes are detected. Sometimes, the computer system can iterate through the blocks 808-824 until a threshold amount of iterations are performed. If no condition/operational changes are detected in block 824, the process 800 can stop.

FIG. 9 is a flowchart of a process 900 for dynamically adjusting task assignment priorities based on operational conditions. As an illustrative example, the process 900 can be performed to dynamically adjust task assignment priorities between minimizing travel distance and meeting timing requirements according to operational conditions of a facility or warehouse. If a worker (or a set of workers), for example, is ahead of schedule, travel distance can be prioritized. As another example, if the worker (or the set of workers) is behind schedule, the system described herein may increase the weighting on minimizing travel distance to catch up. The weighting can dynamically change based on how far behind schedule the worker may be. Therefore, the further behind in schedule, the more the system described herein can minimize travel distance. As yet another example, if the worker (or the set of workers) is on time, the disclosed system can be more opportunistic and can more equally weigh travel distance for tasks. The balance of these factors can sometimes be determined by a number of late tasks relative to available workers in the facility (e.g., at a current time, at an upcoming time). The process 900 further can reduce overall computational resource usage (e.g., CPU cycles, network bandwidth) by at least threshold amounts or levels to improve operations of computer systems described herein and real-time accuracy of these operations.

The process 900 can be combined with one or more other processes described herein, such as the process 400 in FIGS. 4A, 4B, 4C, 4D, and 4E, and process 700, 800, and 1000 in FIGS. 7, 8, and 10A and 10B, respectively. Operations in the process 900 can be performed by components of the computer system 114 described herein. In some implementations, one or more of the operations can be performed by other computer systems, computing devices, network devices, and/or edge devices. For illustrative purposes, the process 900 is described from the perspective of a computer system.

Referring to the process 900 in FIG. 9, the computer system can receive facility operational data in block 902. The data can include but is not limited to late and/or at-risk late tasks (block 904), total tasks due within a threshold window of time (block 906), and/or available workers and their associated workloads (block 908). The facility operational data can be received from computing devices throughout the facility (e.g., handheld devices or other devices used by workers in the facility), scheduling systems, and/or WMSs.

In block 910, the computer system can calculate a lateness ratio of late tasks to the total tasks and/or available capacity. Sometimes, the lateness ratio can be determined on a task level so that a lateness ratio is determined for each task. As another example, the lateness ratio can be determined on a total task level so that a lateness ratio is determined for an aggregate of late tasks in the facility. The lateness ratio can be a numeric value. A low ratio value (or a ratio value that is less than a predetermined threshold level) can indicate that the facility is ahead of schedule with respect to task completion. A high ratio value (or a ratio value that is greater than a predetermined threshold level) can indicate that the facility is running behind schedule with respect to task completion.

The computer system can dynamically adjust weights based on the lateness ratio in block 912. The weights can include one or more weights for minimizing travel distance (block 914). The weights can include one or more weights for meeting timing and/or urgency constraints (block 916). Sometimes, dynamically adjusting the weights can include emphasizing or increasing a distance minimization when the lateness ratio is low or less than a predetermined threshold level (block 918). Sometimes, dynamically adjusting the weights can include emphasizing or increasing timing when the lateness ratio is high or greater than the threshold level (block 920). The weights can be numeric values.

For each task, the computer system can apply the dynamic weights to determine a respective task score (block 922). Sometimes, the respective task score can be determined based on a combination of factors, including but not limited to an urgency factor (e.g., remaining time to complete the task), a normalized travel distance for the task, a congestion penalty score (refer to FIG. 8), and/or other constraints associated with task completion (e.g., worker skills, priorities of other tasks).

In block 924, the computer system can sort the tasks based on respective task scores. The tasks can be sorted from highest to lowest scores. Sometimes, the tasks can be sorted from lowest to highest scores.

The computer system can also assign the tasks to the workers based on the sorting in block 926. For example, a highest-scoring task can be assigned first to an available worker to ensure that that particular task does not fall further behind in schedule/that the particular task is completed on time. As another example, if overall operations/task completion is on schedule or even ahead of schedule, the computer system may assign a combination of lowest-scoring tasks and highest-scoring tasks. In such scenarios, the computer system may only assign the lowest-scoring tasks for at least a threshold amount of time or until conditions change in the facility (e.g., global efficiency of the facility goes down, additional trucks arrive at the facility, congestion increases or is expected to increase in one or more zones of the facility, fewer workers will be working for an upcoming period of time).

The computer system can then determine if there has been a change in the facility operational data in block 928. The change can include task completion, a new task ready for execution, worker availability, etc. The change can also include any one or more examples of changes described above with respect to block 926.

If there is a change in the facility operational data, the computer system can recompute the lateness ratio based on the change in the facility operational data (block 930) and return to block 912. The computer system can then iterate through blocks 912-928 until there are no additional changes in the operational data and/or a threshold condition is met (e.g., threshold quantity of iterations of blocks 912-928). If the computer system does not detect a change in the facility operational data in block 928, then the process 900 can stop.

As an illustrative example of the process 900, if operations/task performance in the facility are ahead of schedule (e.g., ahead by a predetermined amount of tasks and/or time), the computer system can emphasize minimizing distance traveled for scoring and assigning tasks. More specifically, if the lateness ratio is low or less than a threshold amount/value (e.g., only 1 task is late out of 20 tasks), then the computer system can prioritize minimizing the travel distance amongst available workers. The result of this can include longer (e.g., timewise) but efficient routes.

As another illustrative example of the process 900, if the operations/task performance are behind schedule (e.g., behind by a predetermined amount of tasks and/or time), the computer system can emphasis timing in order to catch up. More specifically, if the lateness ratio is high or greater than a threshold amount/value (e.g., there are 7 late tasks out of 20 tasks), then timing can become critical and the computer system can prioritize assigning shorter paths for the tasks to the available workers. The computer system may also prioritize urgent tasks to be performed before other tasks.

FIGS. 10A and 10B are a flowchart of a process 1000 for granular and real-time task assignment. In some implementations, the process 1000 can be performed to enable workers in a facility or warehouse to request additional, location-specific instructions after completing tasks, thereby allowing for granular and efficient task execution. For example, after completing a task (e.g., scanning a pallet), a worker can poll the disclosed system with location-specific information to request assignment of additional tasks. This enables the worker to receive more granular instructions for a task they are performing including additional instructions to perform other tasks, such as scanning nearby pallets or performing multiple related tasks. This can increase productivity and decision-making at the point of work. The process 1000 further can reduce overall computational resource usage (e.g., CPU cycles, network bandwidth) by at least threshold amounts or levels to improve operations of computer systems described herein and real-time accuracy of these operations.

The process 1000 can be combined with one or more other processes described herein, such as the process 400 in FIGS. 4A, 4B, 4C, 4D, and 4E, and process 700, 800, and 900 in FIGS. 7, 8, and 9, respectively. Operations in the process 1000 can be performed by components of the computer system 114 described herein. In some implementations, one or more of the operations can be performed by other computer systems, computing devices, network devices, and/or edge devices. For illustrative purposes, the process 1000 is described from the perspective of a computer system.

Referring to the process 1000 in FIGS. 10A and 10B, the computer system can receive information indicating completion of a task by a worker in block 1002. The received information can include device input by the worker using a handheld scanner, mobile application presented at a mobile device, and/or other computing devices used by the worker. The information can sometimes be received from a computing system, such as a logistics system and/or WMS associated with the facility. The information can sometimes be received from other components in the facility, such as but not limited to cameras and/or sensors. Sometimes, the information can include a system-acknowledgement of a last scan and/or action that was performed by the worker. In some implementations, the received information can include a current location of the worker and/or a location where the task was completed by the worker.

In block 1004, the computer system can receive a worker poll request for one or more additional tasks. The worker poll request can include a worker location (block 1006), information about a last completed task (block 1008), and/or current operational context (block 1010). The worker location (block 1006) can be a current location, such as coordinates, zone, and/or other information about where the worker is located in the facility. The information about the last completed task (block 1008) can indicate start and/or finish locations associated with the task, a type of task, whether and what equipment was used to complete the task, time it took to complete the task, etc. The current operational context (block 1010) can include a zone, dock area, or other information related to the last completed task, the current location of the worker, and/or other tasks that are being performed or have been performed proximate the location of the worker. In some implementations, the poll request can be automatically transmitted or otherwise provided by the worker's device to the computer system. As a result, the worker can dynamically and automatically be assigned tasks to avoid potential or significant downtime between tasks.

The computer system can also retrieve a queue of available tasks (e.g., from a task scheduler, from a WMS described herein) (block 1012). As described herein, the queue can include tasks that have yet to be assigned to workers. Sometimes, the queue can include tasks that have been assigned, started, in progress, and/or completed.

Accordingly, the computer system can filter out tasks from the queue that are already assigned to other workers and/or marked as critical to generate a filtered list in block 1014.

The computer system can identify candidate tasks in the filtered list that satisfy one or more nearby criteria (block 1016). The computer system can identify candidate tasks that are in a threshold proximity to the worker location (e.g., their current location or a location that is close/nearby their current location) in block 1018.

As an illustrative example of block 1018, the worker can finish scanning pallet AAA in zone A in the facility. The computer system can identify nearby tasks within a 10 meter radius that can include scanning pallet AAB in the same rack as the pallet AAA, moving an empty pallet to a staging area 5 meters away, and/or verifying a label on pallet AAC in an adjacent bay. As another illustrative example, the worker can be located at dock door 7 in the facility. The computer system can identify the following nearby candidate tasks that are currently unassigned: loading pallet BBB onto truck 7 at the same dock door 7 and/or scanning pallet BBA that was removed from truck 8 at adjacent dock door 8.

Additionally or alternatively, the computer system can identify candidate tasks that logically relate to the last completed task (block 1020). As an illustrative example, the last completed task can be loading pallet CCC onto truck 12. The computer system can identify one or more of the following related candidate tasks: loading other pallets for truck 12, confirming weight and/or other departure requirements for the truck 12, and/or reviewing and/or printing a manifest for the truck 12. As another illustrative example, the last completed task can be scanning an inbound pallet for storage. The computer system can identify one or more of the following related candidate tasks: updating an inventory system for the scanned pallet, scanning associated pallets in a same shipment, scanning adjacent pallets, and/or moving the scanned pallet to a designated storage area or zone.

Next, the computer system can rank the candidate tasks into a ranked list based on one or more ranking criteria (block 1022). The candidate tasks can be ranked based on proximity to the worker, operational priorities (e.g., timing, congestion penalties described above), worker capabilities, worker permissions, and/or availability, location, and/or capabilities of other nearby workers.

The computer system can select a top-ranked candidate task from the ranked list in block 1024. Sometimes, the computer system can select multiple top-ranked candidate tasks.

In block 1026, the computer system can generate and return instructions to a device of the worker to complete the selected task and/or additional tasks in proximity to the worker location and/or the selected task. As a result, the worker can perform multiple additional tasks without significant idle time between tasks. In some implementations, the process 1000 may optionally stop after block 1026.

The computer system can receive input indicating that the worker is performing the selected task (block 1028). The input can be similar to the received information in block 1002 (e.g., indication from the worker's device, system-generated acknowledgement). The computer system can mark the selected task as in progress, based on the received input (block 1030). The computer system can optionally remove the marked task from the filtered list in block 1032 so that the marked task does not get reassigned to other workers.

In block 1034, the computer system can determine whether it is receiving more worker poll requests. If yes, then the computer system can return to block 1004 and iterate through 1004-1034 until no more worker poll requests are received (or a timeout condition is met such as threshold quantity of worker poll requests are received and/or the operations in the facility are sufficiently ahead of schedule by at least a threshold amount of time). If the computer system determines there are no more worker poll requests in block 1034, the computer system can perform standard task assignment operations described herein (block 1036).

Although the disclosed concepts include those defined in the attached claims, it should be understood that the concepts can also be defined in accordance with one or more of the following embodiments.
Embodiment 1 is a computer-implemented method for ordering tasks to move items in a storage facility, the method comprising: identifying, by a computing system, a collection of item-movement tasks to perform in a storage facility, each item-movement task in the collection of item-movement tasks indicating movement of a respective item from a respective source location to a respective destination location; distributing, by the computing system, item-movement tasks in the collection of item-movement tasks among multiple queues of item-movement tasks corresponding to multiple moving machines, to form a first state of the multiple queues of item-movement tasks, such that each moving machine of the multiple moving machines has a respective queue of item-movement tasks to perform, including: a first moving machine of the multiple moving machines having a first queue of item-movement tasks from among the multiple queues of item-movement tasks, and a second moving machine of the multiple moving machines having a second queue of item-movement tasks from among the multiple queues of item-movement tasks; determining, by the computing system, a first value that indicates utilization of the multiple moving machines based on the multiple moving machines performing the multiple queues of item-movement tasks while the multiple queues of item-movement tasks have the first state; swapping, by the computing system, a first item-movement task from the first queue of item-movement tasks with a second item-movement task from the second queue of item-movement tasks, to form a second state of the multiple queues of item-movement tasks, such that: the first queue of item-movement tasks to be performed by the first moving machine no longer includes the first item-movement task and now includes the second item-movement task, and the second queue of item-movement tasks to be performed by the second moving machine no longer includes the second item-movement task and now includes the first item-movement task; determining, by the computing system, a second value that indicates utilization of the multiple moving machines based on the multiple moving machines performing the multiple queues of item-movement tasks while the multiple queues of item-movement tasks have the second state; determining, by the computing system based on comparison of the first value to the second value, that utilization of the multiple moving machines is greater when the multiple queues of item-movement tasks have the first state; and swapping, by the computing system based on determining that utilization of the multiple moving machines is greater when the multiple queues of item-movement tasks have the first state, the first item-movement task in the second queue of item-movement tasks with the second item-movement task in the first queue of item-movement tasks, to revert the multiple queues of item-movement tasks to the first state.
Embodiment 2 is the computer-implemented method of embodiment 1, wherein the computing system is configured to leave the multiple queues of item-movement tasks in the second state as a result of determining, based on comparison of the first value to the second value, that utilization of the multiple moving machines is greater when the multiple queues of item-movement tasks have the second state.
Embodiment 3 is the computer-implemented method of any one of embodiments 1 and 2, further comprising sending, by the computing system, first instructions to cause the first moving machine to perform a next-to-perform task from the first queue of item-movement tasks; and sending, by the computing system, second instructions to cause the second moving machine to perform a next-to-perform task from the second queue of item-movement tasks.
Embodiment 4 is the computer-implemented method of any one of embodiments 1 through 3, further comprising randomly selecting, by the computing system, the first item-movement task and the second item-movement task, for the swapping of the first item-movement task and the second item-movement task, among item-movement tasks in the multiple queues of item-movement tasks.
Embodiment 5 is the computer-implemented method of any one of embodiments 1 through 4, wherein each item-movement task in the collection of item-movement tasks indicates movement of a respective pallet from a respective source location to a respective destination location; and at least some of the multiple moving machines are lift trucks.
Embodiment 6 is the computer-implemented method of any one of embodiments 1 through 5, wherein distributing the item-movement tasks in the collection of item-movement tasks among the multiple queues of item-movement tasks includes randomly distributing item-movement tasks in the collection of item-movement tasks among the multiple queues of item-movement tasks.
Embodiment 7 is the computer-implemented method of any one of embodiments 1 through 6, wherein the first value that indicates utilization of the multiple moving machines indicates a first amount that the multiple moving machines are without an item to move during performance of the multiple queues of item-movement tasks while the multiple queues of item-movement tasks have the first state; and the second value that indicates utilization of the multiple moving machines indicates a second amount that the multiple moving machines are without an item to move during performance of the multiple queues of item-movement tasks while the multiple queues of item-movement tasks have the second state.
Embodiment 8 is the computer-implemented method of any one of embodiments 1 through 7, further comprising: determining, by the computing system, a third value that indicates utilization of the multiple moving machines based on the multiple moving machines performing the multiple queues of item-movement tasks while the multiple queues of item-movement tasks have a third state; modifying, by the computing system, a third item-movement task from the first queue of item-movement tasks while the multiple queues of item-movement tasks have the third state (i) from having an original destination location at which to place an item to be moved by the third-item-movement task (ii) to having an alternative destination location at which to place the item to be moved by the third item-movement task, to form a fourth state of the multiple queues of item-movement tasks; determining, by the computing system, a fourth value that indicates utilization of the multiple moving machines based on the multiple moving machines performing the multiple queues of item-movement tasks while the multiple queues of item-movement tasks have the fourth state; determining, by the computing system based on comparison of the third value to the fourth value, that utilization of the multiple moving machines is greater when the multiple queues of item-movement tasks have the third state; and modifying, by the computing system based on having determined that the utilization of the multiple moving machines is greater when the multiple queues of item-movement tasks have the third state, the third item-movement task to have the original destination location, to revert the multiple queues of item-movement tasks to the third state.
Embodiment 9 is the computer-implemented method of any one of embodiments 1 through 8, wherein the computing system is configured to leave the multiple queues of item-movement tasks in the fourth state as a result of determining, based on comparison of the third value to the fourth value, that utilization of the multiple moving machines is greater when the multiple queues of item-movement tasks have the fourth state.
Embodiment 10 is the computer-implemented method of any one of embodiments 1 through 9, further comprising: determining, by the computing system, a third value that indicates utilization of the multiple moving machines based on the multiple moving machines performing the multiple queues of item-movement tasks while the multiple queues of item-movement tasks have a third state; modifying, by the computing system, a third item-movement task from the first queue of item-movement tasks while the multiple queues of item-movement tasks have the third state (i) from selecting an original item from an original source location (ii) to selecting an alternative item from an alternative location to form a fourth state of the multiple queues of item-movement tasks, the alternative item being a same type of item as the original item; determining, by the computing system, a fourth value that indicates utilization of the multiple moving machines based on the multiple moving machines performing the multiple queues of item-movement tasks while the multiple queues of item-movement tasks have the fourth state; determining, by the computing system based on comparison of the third value to the fourth value, that utilization of the multiple moving machines is greater when the multiple queues of item-movement tasks have the third state; and modifying, by the computing system based on having determined that the utilization of the multiple moving machines is greater when the multiple queues of item-movement tasks have the third state, the third item-movement task to select the original item from the original source location, to revert the multiple queues of item-movement tasks to the third state.
Embodiment 11 is a computing system comprising one or more processors and one or more computer-readable devices including instructions that, when executed by the one or more processors, cause the computing system to perform the computer-implemented method of any one of embodiments 1 to 10.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A method for computationally efficient scoring and prioritization of resources, the method comprising:
receiving a data request for a resource assignment in an operational environment;
retrieving a queue of candidate resources associated with the operational environment;
generating a dynamic score for at least one candidate resource in the queue of candidate resources based at least in part on the received data request;
updating a prioritized resource list based on the dynamic score for the at least one candidate resource, wherein the prioritized resource list comprises a plurality of resources having respective dynamic scores;
assigning a resource from the prioritized resource list that satisfies one or more assignment criteria based on the received data request; and
returning instructions that cause the assigned resource to be executed.

2. The method of claim 1, wherein the data request comprises a current location and last-resource information.

3. The method of claim 1, wherein the resource comprises a task to be performed in the operational environment, wherein the operational environment comprises a facility.

4. The method of claim 1, wherein generating the dynamic score for the at least one candidate resource in the queue of candidate resources comprises identifying a subset of candidate resources in the queue of candidate resources that is associated with the received data request, wherein the subset of candidate resources comprises the at least one candidate resource.

5. The method of claim 1, wherein, in response to receiving a second data request for a second resource assignment, the method further comprises:
identifying a subset of resources in the prioritized resource list that are associated with the second data request;
recomputing respective dynamic scores for the subset of resources; and
updating the prioritized resource list based on the recomputed dynamic scores for the subset of resources.

6. The method of claim 5, wherein the second data request comprises completion of scanning a pallet in the operational environment.

7. The method of claim 5, wherein the second data request comprises an update in dock door assignment in the operational environment or truck ETA to the operational environment.

8. The method of claim 1, wherein the generating, updating, and assigning are configured to lower CPU cycles by at least a threshold amount.

9. The method of claim 1, wherein updating the prioritized resource list comprises increasing or decreasing a position of the at least one candidate resource in the prioritized resource list based on the dynamic score.

10. The method of claim 1, wherein the prioritized resource list is a heap and the dynamic scores of the plurality of resources are heap keys for the plurality of resources.

11. The method of claim 1, wherein the plurality of resources are ranked from highest dynamic score to lowest dynamic score in the prioritized resource list.

12. The method of claim 1, wherein returning the instructions that cause the assigned resource to be executed comprises transmitting instructions to a facility vehicle in the operational environment that, when executed, causes the facility vehicle to perform operations based on the assigned resource.

13. The method of claim 1, wherein assigning the resource from the prioritized resource list that satisfies the one or more assignment criteria based on the received data request comprises selecting and assigning a highest-ranked resource in the prioritized resource list.

14. The method of claim 1, wherein:
the plurality of resources are a plurality of tasks to be performed in the operational environment,
the data request is received from a worker in the operational environment,
the data request comprises a location of the worker in the operational environment, and
wherein assigning the resource from the prioritized resource list that satisfies the one or more assignment criteria based on the received data request comprises selecting and assigning a highest-ranked resource in the prioritized resource list that is within a threshold distance of the location of the worker in the operational environment.

15. The method of claim 1, wherein the method further comprises:
generating congestion scores for each zone in a plurality of zones in the operational environment;
identifying and tagging zones in the plurality of zones as high congestion zones based on a determination that the tagged zones have corresponding congestion scores that exceed a threshold value;
for each candidate resource in the queue of candidate resources, applying a penalty score to a respective dynamic score for the candidate resource to generate an updated dynamic score for the candidate resource based on the candidate resource being associated with at least one of the high congestion zones; and
updating the prioritized resource list based on the updated dynamic score for the candidate resource.

16. The method of claim 15, wherein updating the prioritized resource list based on the updated dynamic score for the candidate resource comprises deprioritizing the candidate resource in the prioritized resource list.

17. A system for computationally efficient scoring and prioritization of resources, the system comprising:
one or more processors; and
memory storing instructions that, when executed, cause the one or more processors to perform operations comprising:
receiving a data request for a resource assignment in an operational environment;
retrieving a queue of candidate resources associated with the operational environment;
generating a dynamic score for at least one candidate resource in the queue of candidate resources based at least in part on the received data request;
updating a prioritized resource list based on the dynamic score for the at least one candidate resource, wherein the prioritized resource list comprises a plurality of resources having respective dynamic scores;
assigning a resource from the prioritized resource list that satisfies one or more assignment criteria based on the received data request; and
returning instructions that cause the assigned resource to be executed.

18. The system of claim 17, wherein, in response to receiving a second data request for a second resource assignment, the operations further comprise:
identifying a subset of resources in the prioritized resource list that are associated with the second data request;
recomputing respective dynamic scores for the subset of resources; and
updating the prioritized resource list based on the recomputed dynamic scores for the subset of resources.

19. The system of claim 17, wherein:
the plurality of resources are a plurality of tasks to be performed in the operational environment,
the data request is received from a worker in the operational environment,
the data request comprises a location of the worker in the operational environment, and
wherein assigning the resource from the prioritized resource list that satisfies the one or more assignment criteria based on the received data request comprises selecting and assigning a highest-ranked resource in the prioritized resource list that is within a threshold distance of the location of the worker in the operational environment.

20. The system of claim 17, wherein the operations further comprise:
generating congestion scores for each zone in a plurality of zones in the operational environment;
identifying and tagging zones in the plurality of zones as high congestion zones based on a determination that the tagged zones have corresponding congestion scores that exceed a threshold value;
for each candidate resource in the queue of candidate resources, applying a penalty score to a respective dynamic score for the candidate resource to generate an updated dynamic score for the candidate resource based on the candidate resource being associated with at least one of the high congestion zones; and
updating the prioritized resource list based on the updated dynamic score for the candidate resource.
